(19) United States
(12) Patent Application Publication
(10) Pub. No.: US 2026/0370975 A1
(43) Pub. Date: Nov. 19, 2026

(54) IMAGE SENSOR, METHOD OF OPERATING THE SAME, AND ELECTRONIC APPARATUS INCLUDING IMAGE SENSOR

(71) Applicant: SAMSUNG ELECTRONICS CO., LTD., Suwon-si (KR)

(72) Inventors: Jaejin JUNG, Suwon-si (KR); Sungyong Kim, Suwon-si (KR); Sinhwan Lim, Suwon-si (KR)

(73) Assignee: SAMSUNG ELECTRONICS CO., LTD., Suwon-si (KR)

(21) Appl. No.: 19/207,917

(22) Filed: May 14, 2025

(51) Int. Cl. H04N 25/772; H04N 25/677; H04N 25/78

(52) U.S. Cl. CPC H04N 25/772; H04N 25/677; H04N 25/78

(57) ABSTRACT

An image sensor may include a pixel array including a plurality of pixels and a plurality of column lines connected to the plurality of pixels, a ramp signal generator configured to generate a ramp signal and adjust an offset of the ramp signal at each read-out period of the pixel array, and an analog-to-digital conversion circuit including a plurality of comparators configured to receive a plurality of pixel signals from the plurality of column lines and the ramp signal from the ramp signal generator, compare each of the plurality of pixel signals with the ramp signal to obtain a plurality of comparison results, and perform analog-to-digital conversion on the plurality of comparison results to generate pixel data corresponding to the plurality of pixel signals, respectively.

### BACKGROUND

Embodiments of the present application relate to a semiconductor circuit, and more particularly, to an image sensor performing analog dithering, a method of operating the same, and an electronic device including the image sensor.

An image sensor generates an image of a target object by using photoelectric conversion elements that respond to the intensity of light reflected from the target object. The image sensor may generate the image through analog-to-digital conversion of electrical signals generated by a photoelectric conversion element. Fixed pattern noise may occur during an analog-to-digital conversion process, which may deteriorate the image quality. Various techniques are being researched to remove or reduce such fixed pattern noise.

### SUMMARY

One or more embodiments of the present disclosure provide an image sensor that generates an image with improved fixed pattern noise and enhanced image quality, a method of operating the same, and an electronic apparatus including the image sensor.

According to an aspect of the present disclosure, an image sensor may include a pixel array including a plurality of pixels and a plurality of column lines connected to the plurality of pixels, a ramp signal generator configured to generate a ramp signal and adjust an offset of the ramp signal at each read-out period of the pixel array; and an analog-to-digital conversion circuit including a plurality of comparators configured to receive a plurality of pixel signals from the plurality of column lines and the ramp signal from the ramp signal generator, compare each of the plurality of pixel signals with the ramp signal to obtain a plurality of comparison results, and perform analog-to-digital conversion on the plurality of comparison results to generate pixel data corresponding to the plurality of pixel signals, respectively.

According to another aspect of the present disclosure, a method of operating an image sensor including a pixel array including a plurality of pixels, may include generating a first ramp signal including a first offset, receiving first pixel signals from pixels in a first row of the pixel array, among the plurality of pixels, generating first pixel data by performing analog-to-digital conversion on the first pixel signals based on the first ramp signal, generating a second ramp signal including a second offset different from the first offset, receiving second pixel signals from pixels in a second row of the pixel, among the plurality of pixels, and generating second pixel data by performing analog-to-digital conversion on the second pixel signals based on the second ramp signal.

According to another aspect of the present disclosure, an electronic apparatus may include an image sensor and a processor. The image sensor may include a pixel array including a plurality of pixels, and may be configured to generate a ramp signal by adding an offset, which is set differently for each of a plurality of rows of the pixel array, to a reference ramp signal during each read-out period, generate a plurality of comparison result signals by comparing the ramp signal with a plurality of pixel signals that is output from the plurality of pixels, respectively, and generate image data through analog-to-digital conversion of the plurality of comparison result signals. The processor may be configured to process the image data received from the image sensor.

### BRIEF DESCRIPTION OF DRAWINGS

Embodiments of the inventive concept will be more clearly understood from the following detailed description taken in conjunction with the accompanying diagrams in which:

FIG. 1 is a block diagram showing an image sensor according to an embodiment;

FIG. 2 is a diagram showing an example implementation of a pixel applied to an image sensor, according to embodiments;

FIG. 3 is a diagram showing conversion of a pixel signal into a pixel value in an image sensor, according to an embodiment;

FIG. 4 is a timing diagram showing a correlated double sampling (CDS) operation of an analog-to-digital (ADC) circuit of FIG. 3 in an image sensor, according to an embodiment;

FIG. 5 is a diagram showing a ramp signal of an image sensor, according to an embodiment;

FIG. 6A is a diagram showing decision points of pixel signals for each column of a pixel array in a CDS operation to which analog dithering is not applied, according to an example embodiment, and FIG. 6B is a diagram showing decision points of pixel signals and quantization values for each column and row of a pixel array in a CDS operation to which analog dithering is not applied, according to an embodiment;

FIG. 7 is a diagram showing decision points and quantization values of pixel signals for each column and row of a pixel array in a CDS operation with analog dithering applied according to an embodiment;

FIGS. 8A and 8B are diagrams showing images generated under dark conditions;

FIGS. 9A and 9B are diagrams showing an analog dithering method according to an embodiment;

FIG. 10 is a diagram showing an analog dithering method according to an embodiment;

FIGS. 11A and 11B are diagrams showing a ramp signal generator according to an embodiment;

FIG. 12A is a diagram showing a reference current cell according to an embodiment, and FIG. 12B is a diagram showing an offset current cell according to an embodiment;

FIGS. 13A and 13B are diagrams showing a ramp signal generator according to an embodiment;

FIG. 14 is a diagram showing a second offset current cell according to an embodiment;

FIG. 15 is a flowchart of a method of operating an image sensor, according to an embodiment; and

FIG. 16 is a block diagram showing an electronic apparatus including an image sensor, according to an embodiment.

### DETAILED DESCRIPTION

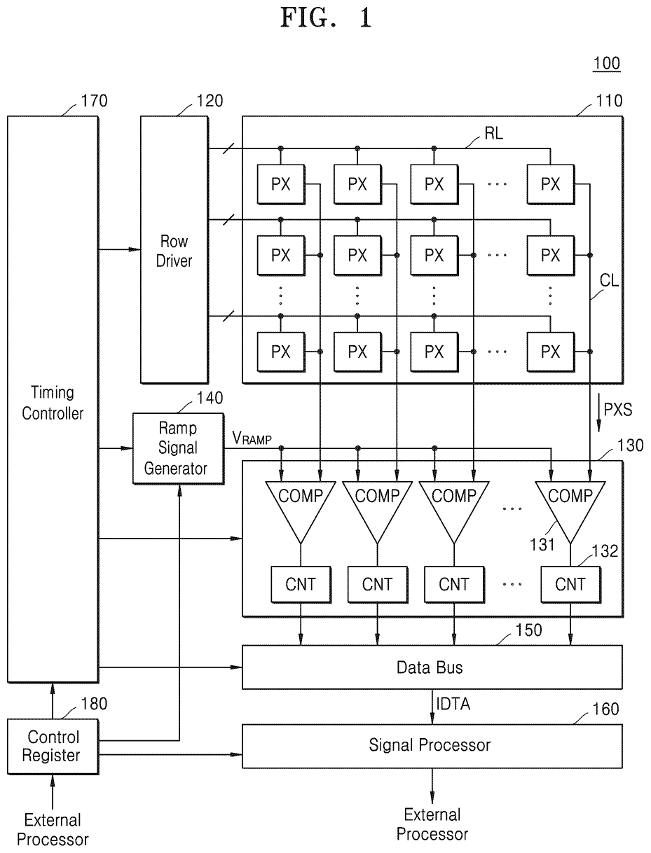

FIG. 1 is a block diagram showing an image sensor 100 according to an embodiment.

The image sensor 100 may generate image data IDTA by converting a received optical signal (image information) into an electrical digital signal. The image sensor 100 may be installed on an electronic device having a function of sensing an image or light. For example, the image sensor 100 may be installed on an electronic device such as a camera, a smartphone, a wearable device, an Internet of Things (IoT) device, a household appliance, a tablet personal computer (PC), a personal digital assistant (PDA), a portable multimedia player (PMP), a navigation device, a drone, and an advanced drivers assistance system (ADAS). Also, the image sensor 100 may be installed on an electronic device provided as a component of a vehicle, a furniture, a manufacturing facility, a door, and various measuring devices.

Referring to FIG. 1, the image sensor 100 may include a pixel array 110, a row driver 120, an analog-to-digital conversion circuit (hereinafter, referred to as an ADC circuit) 130, a ramp signal generator 140, a data bus 150, a signal processor 160, a timing controller 170, and a control register 180. The row driver 120, the ADC circuit 130, and the ramp signal generator 140 may be referred to as a read-out circuit.

The pixel array 110 includes a plurality of row lines RL, a plurality of column lines CL, and a plurality of pixels PX connected to the plurality of row lines RL and the plurality of column lines CL and arranged in rows and columns. The plurality of pixels PX may be active pixel sensors (APS).

According to an embodiment, the pixels PX arranged in the same column may be connected to the same column line CL. However, the inventive concept is not limited thereto, and, depending on the arrangement of the pixels PX, the pixels PX arranged in the same column may be connected to different column lines CL. A pixel PX may output a pixel signal PXS (e.g., a pixel voltage) through a corresponding column line CL.

The pixel PX may detect light using a photoelectric conversion element and output an electrical signal according to detected light. The photoelectric conversion element may be a light-sensing element including an organic material or an inorganic material. Examples of the photoelectric conversion element may include a photo diode (an inorganic photo diode), an organic photo film, a perovskite photo diode, a photo transistor, a photo gate, a pinned photo diode, etc. Hereinafter, a photo diode will be used as an example to describe a photoelectric conversion element.

A micro lens for condensing light may be disposed above each of the plurality of pixels PX or above each pixel group including the pixels PX adjacent to one another. A color filter for transmitting light of a particular spectral range may be disposed above each of the plurality of pixels PX, and each of the plurality of pixels PX may detect light of a particular spectral range from light received through a micro lens based on a corresponding color filter. For example, the pixel array 110 may include a red pixel for converting light in a red spectral region into an electrical signal, a green pixel for converting light in a green spectral region into an electrical signal, and a blue pixel for converting light in a blue spectral region into an electrical signal. However, the inventive concept is not limited thereto, and the pixel array 110 may further include white pixels, or the pixel array 110 may include pixels according to other color combinations, such as cyan pixels, yellow pixels, green pixels, and magenta pixels.

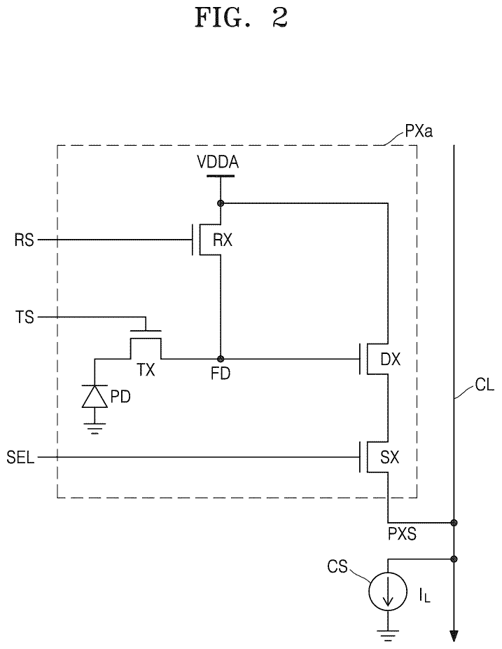

FIG. 2 is a diagram showing an example implementation of a pixel applied to an image sensor, according to embodiments.

Referring to FIG. 2, a pixel PXa may include a photo diode PD, a transmission transistor TX, a reset transistor RX, a driving transistor DX (or called a source follower), and a selection transistor SX. The transmission transistor TX, the reset transistor RX, and the selection transistor SX may operate in response to control signals provided from a row driver (e.g., the row driver 120 of FIG. 1). The control signals may include a transmission control signal TS, a reset control signal RS, and a selection signal SEL.

The reset transistor RX may reset the floating diffusion node FD in response to the reset control signal RS. The reset transistor RX may be turned on to apply an analog power voltage VDDA to the floating diffusion node FD. Charges remaining in the floating diffusion node FD is removed, and the voltage level of the floating diffusion node FD may become equal to the voltage level of the analog power voltage VDDA.

The photo diode PD may generate and store charges depending on the intensity of received light. For example, the photodiode PD may generate charges, that is, electrons (i.e., negative charges) and holes (i.e., positive charges), in proportion to the amount of incident light.

The transmission transistor TX connected between the photo diode PD and the floating diffusion node FD is turned on in response to the transmission control signal TS and transmit charges accumulated in the photo diode PD to the floating diffusion node FD. Charges received through the transmission transistor TX may be accumulated in the floating diffusion node FD. A capacitor (parasitic capacitor) may be formed in the floating diffusion node FD, and charges may be accumulated in the parasitic capacitor. The floating diffusion node FD has a voltage level corresponding to accumulated charges. At this time, a ratio at which the charges of the floating diffusion node FD are converted into a voltage (e.g., the voltage of the floating diffusion node FD) may be referred to as a conversion gain. According to an embodiment, the capacitance of a capacitor of the floating diffusion node FD may be changed, and the conversion gain is inversely proportional to the capacitance. As the capacitance increases, the conversion gain decreases, and, as the capacitance decreases, the conversion gain increases.

A first terminal of the driving transistor DX may be connected to the selection transistor SX, and the analog power voltage VDDA may be applied to a second terminal of the driving transistor DX. A first terminal of the selecting transistor SX may be connected to the driving transistor DX, whereas a second terminal of the selecting transistor SX may be connected to the column line CL. The selection transistor SX may be turned on or off in response to the selection signal SEL provided to the gate of the selection transistor SX. When the selection transistor SX is turned on during a read-out operation for the pixel PXa, the driving transistor DX may operate as a source follower based on a bias current IL generated by a current source CS connected to the column line CL, and the driving transistor DX may output a signal voltage corresponding to the voltage level of the floating diffusion node FD as the pixel signal PXS.

After the reset transistor RX is turned on and the floating diffusion node FD is reset, a reset signal corresponding to the voltage level (e.g., the reset level) of the floating diffusion node FD may be output as the pixel signal PXS. Next, after the transmission transistor TX is turned on and charges generated by the photo diode PD are accumulated in the floating diffusion node FD, an image signal corresponding to the voltage level (e.g., the signal level) of the floating diffusion node FD may be output as the pixel signal PXS.

The pixel PXa illustrated in FIG. 2 may be applied to the pixel PX of FIG. 1 is described. However, the inventive concept is not limited thereto, and one of pixels of various structures may be implemented as the pixel PX. For example, the pixel PX may further include a conversion gain transistor connected between the reset transistor RX and the floating diffusion node FD, and the conversion gain may be changed depending on the turn-on and the turn-off of the conversion gain transistor. For example, the pixel PX may include a plurality of photo diodes PD and a plurality of transmission transistors TX.

The row driver 120 drives the pixel array 110 in units of one or more rows. The row driver 120 may decode a row control signal (e.g., a row address) received from the timing controller 170 and select at least one row to be read out from among a plurality of rows of the pixel array 110 in response to a decoded row control signal. The row driver 120 may sequentially select a plurality of rows of the pixel array 110 in a plurality of read-out periods included in one frame period.

The row driver 120 may provide control signals, such as a reset control signal, a selection signal, a transmission control signal, and a conversion control signal, to the pixels PX located in a selected row through row lines RL. The pixels PX located in a selected row output the pixel signals PXS, such as pixel voltages, in response to received control signals. Each of the pixels PX located in the selected row may output a reset signal and an image signal as the pixel signal PXS to the ADC circuit 130 through a corresponding column line CL from among the plurality of column lines CL. Therefore, one row of the pixel array 110 may be read out, and a plurality of rows of the pixel array 110 to be read out in a plurality of read-out periods.

The ADC circuit 130 may convert a plurality of pixel signals PXS (e.g., a plurality of pixel voltages) provided by the pixel array 110 into a plurality of pixel values based on a ramp signal V_{RAMP} provided by the ramp signal generator 140. The ADC circuit 130 may include a plurality of comparators 131 and a plurality of counters 132. According to an embodiment, the ADC circuit 130 may further include a plurality of buffers for buffering the ramp signal V_{RAMP}.

The ADC circuit 130 may convert each of the plurality of pixel signals PXS into a pixel value using the correlated double sampling (CDS) method. The ADC circuit 130 may sequentially receive a reset signal and an image signal as the pixel signals PXS, generate a reset value and a signal value through digital-to-analog conversion of the reset signal and the image signal, respectively, and generate a pixel value by subtracting the reset value from the signal value.

A comparator 131 may be referred to as a CDS circuit. The comparator 131 may receive the pixel signal PXS received through a corresponding column line CL from among the plurality of column lines CL and receive the ramp signal V_{RAMP} from the ramp signal generator 140. The comparator 131 may compare the pixel signal PXS with the lamp signal V_{RAMP} and output a comparison result signal. The comparator 131 may output a comparison result signal that transitions from a first level (e.g., logic high) to a second level (e.g., logic low) when the ramp signal V_{RAMP}, which decreases at a specific slope (or linearly), reaches a level equal to or lower than the pixel signal PXS. A time point at which the ramp signal V_{RAMP} becomes equal to the pixel signal PXS and the comparison result signal transitions from the first level to the second level may be referred to as a decision point.

According to the CDS method, the comparator 131 may sample and hold a reset signal provided from the pixel PX and sample an image signal based on the reset signal. The comparator 131 may receive a reset signal as the pixel signal PXS through the column line CL, compare the reset signal with the ramp signal V_{RAMP}, and output a first comparison result signal. The comparator 131 may receive an image signal as the pixel signal PXS through the column line CL, compare the image signal with the ramp signal V_{RAMP}, and output a first comparison result signal.

A counter 132 may generate a reset value based on the first comparison result signal output from the comparator 131 and generate a signal value based on a second comparison result signal. The counter 132 may generate a pixel value (or pixel data) by subtracting a reset value from a signal value.

According to an embodiment, the counter 132 may count a decision point of the comparison result signal, based on a clock signal. The counter 132 may generate a reset value by counting the decision point of the first comparison result signal and may generate a signal value by counting the decision point of the second comparison result signal.

According to an embodiment, the ADC circuit 130 may further include a separate logic circuit, such as latches, adders or subtractors, buffers, etc., for subtracting a reset value from a signal value.

The ramp signal generator 140 (or referred to as a ramp signal generating circuit) may generate the ramp signal V_{RAMP} (or referred to as a ramp voltage) whose level increases (rise) or decreases (falls) at a constant rate. The slope of the ramp signal V_{RAMP} may be varied depending on the analog gain. The ramp signal V_{RAMP} may be provided to the ADC circuit 130 as a reference voltage to be compared with the pixel signal PXS.

The ramp signal generator 140 according to an embodiment may generate the ramp signal V_{RAMP} by adding an offset (dithering offset) to a reference ramp signal. The offset may change a baseline level (e.g., a voltage level) of the ramp signal V_{RAMP} without affecting its overall amplitude or rate of change. The ramp signal generator 140 may change an offset for each read-out period (or for one or more read-out period). According to an embodiment, different offsets may be respectively set for the plurality of rows of the pixel array 110. According to an embodiment, different offsets may be respectively set for one or more rows of the pixel array 110. At each read-out period, the ramp signal generator 140 may generate the ramp signal V_{RAMP} by adding an offset corresponding to a row being read out from among the plurality of rows of the pixel array 110 to a reference ramp signal and provide the ramp signal V_{RAMP} to each of the plurality of comparators 131 of the ADC circuit 130.

For example, during a first read-out period in which the pixel signals PXS are read out from the pixels PX arranged in a first row of the pixel array 110, the ramp signal generator 140 may generate a first ramp signal by adding a first offset set for the first row of the pixel array 110 to a reference ramp signal and provide the first ramp signal as the ramp signal V_{RAMP} to the plurality of comparators 131 of the ADC circuit 130. Pixel signals PXS read out during the first read-out period may be converted into pixel values based on the first ramp signal including the first offset.

During a second read-out period in which the pixel signals PXS are read out from the pixels PX arranged in a second row of the pixel array 110, the ramp signal generator 140 may generate a second ramp signal by adding a second offset set for the second row of the pixel array 110 to the reference ramp signal. The second offset may be different from the first offset. The ramp signal generator 140 may provide the second ramp signal as the ramp signal V_{RAMP} to the plurality of comparators 131 of the ADC circuit 130. The pixel signals PXS read out during the second read-out period may be converted into pixel values based on the second ramp signal including the second offset.

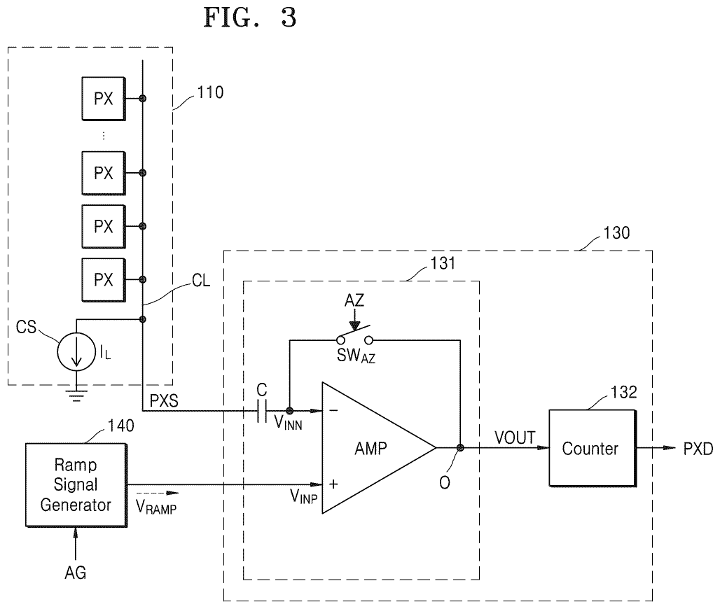

In this regard, the ramp signal generator 140 according to an embodiment may generate the ramp signal V_{RAMP} including an offset and may change the offset included in the ramp signal V_{RAMP} for each read-out period (or for each one or more read-out period). Therefore, the pixel signals PXS read out in different read-out periods, i.e., the pixel signals PXS output from the pixels PX arranged in different rows, may be analog-to-digital converted based on the ramp signal V_{RAMP} including different offsets. In this way, analog dithering may be applied during a CDS operation in which the ADC circuit 130 converts a plurality of pixel signals PXS output from the pixel array 110 into a plurality of pixel values through analog-to-digital conversion. The analog dithering according to the generation of the ramp signal V_{RAMP} including an offset and a change in the offset will be described in detail later with reference to FIGS. 3 to 14.

According to an embodiment, when an analog gain is less than or equal to a reference value, the ramp signal generator 140 may generate a ramp signal V_{RAMP} including different offsets in each read-out period as described above and when the analog gain is greater than the reference value, the ramp signal generator 140 may generate the ramp signal V_{RAMP} that does not include an offset, or the same ramp signal V_{RAMP} in a plurality of read-out periods. For example, the ramp signal generator 140 may generate a reference ramp signal V_{RR} as the ramp signal V_{RAMP}.

The data bus 150 may temporarily store pixel values received from the ADC circuit 130 and then output the image data IDATA including the pixel values to the signal processor 160 (or a device external to the image sensor 100, e.g., a host processor). According to an embodiment, the data bus 150 may provide pixel values to the signal processor 160 in units of at least one line of the pixel array 110. The data bus 150 may include a plurality of column memories and a column decoder, and a plurality of pixel values stored in the plurality of column memories may be output as the image data IDTA under the control of the column decoder.

The signal processor 160 may perform image processing on received image data IDTA. For example, the signal processor 160 may change a data pattern of received image data IDTA (e.g., change raw data into an RGB pattern) or perform image processing such as noise reduction, gain adjustment, binning, downsizing, remosaic, and image quality compensation on the received image data IDTA, wherein the image quality compensation may include signal processing such as black level compensation (or dark level compensation), lens shading compensation, crosstalk compensation, and bad pixel compensation, for example. According to an embodiment, the signal processor 160 may receive first image data and second image data having different luminance and merge the first image data and the second image data to generate an high dynamic range (HDR) image.

The image data IDTA processed by the image signal processor 160 may be transmitted to an external processor. For example, the external processor may be a host processor of an electronic device on which the image sensor 100 is mounted. For example, the external processor may be an application processor of a mobile terminal. The image sensor 100 may transmit the image data IDTA to an external processor according to a data communication method based on a set interface, e.g., mobile industry processor interface (MIPI). The external processor may perform image processing on received image data IDTA. According to an embodiment, the external processor may perform image processing such as 3A adjustment (Auto-focus correction, Auto-white balance, and Auto-exposure), sharpening, gamma control, resolution scaling (video/preview), and demosaicing on the received image data IDTA.

According to an embodiment, some of above-stated image processing may be performed by the signal processor 160 and/or the external processor. For example, the external processor may receive first image data and second image data having different luminance's as the image data IDTA and merge the first image data and the second image data to generate a high dynamic range (HDR) image.

The timing controller 170 may control the operation and the operation timing of the row driver 120, the ADC circuit 130, the ramp signal generator 140, and the data bus 160 by outputting a timing control signal to each of the row driver 120, the ADC circuit 130, the ramp signal generator 140, and the data bus 150.

The control register 180 may receive setup information and configuration data for controlling the operation of the image sensor 100 from an external processor and may control the operation of the signal processor 160, the timing controller 170, and the ramp signal generator 140 based on the setup information and the configuration data. For example, the setup information may include setup values for selecting an operation mode, a shutter mode, etc., and the configuration data may include an exposure time setting value, an analog gain, a digital gain, a lens shading compensation value, a crosstalk coefficient, a frame rate setting value, etc.

The image sensor 100 according to the present embodiment may perform analog dithering as the ramp signal generator 140 generates the ramp signal V_{RAMP} including a different offset for each read-out period (or for each one or more read-out period) and generates pixel values through analog-to-digital conversion of the pixel signals PXS read out during different read-out periods to the ramp signals V_{RAMP} including different offsets.

In the analog-to-digital conversion of the pixel signals PXS, such as a reset signal and an image signal, quantization noise (or quantization error) may occur, which may lead to vertical fixed pattern noise (VFPN) in image data IDTA. However, the image sensor 100 according to an embodiment may randomize and reduce quantization noise by applying analog dithering during the analog-to-digital conversion of the pixel signal PXS. Therefore, the VFPN in the image data IDTA may be reduced, thereby improving the image quality of the image data IDTA.

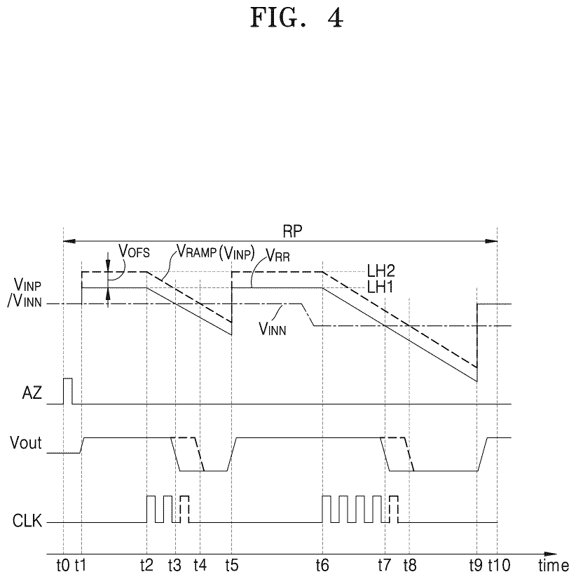

FIG. 3 is a timing diagram showing conversion of a pixel signal into a pixel value in an image sensor, according to an embodiment, and FIG. 4 is a timing diagram showing a CDS operation of the ADC circuit of FIG. 3 in the image sensor, according to an embodiment.

Referring to FIG. 3, the pixels PX arranged in different rows of the pixel array 110 may be connected to the same column line CL, and each of the pixels PX may output the pixel signal PXS to the ADC circuit 130 through the column line CL during a corresponding read-out period from among a plurality of read-out periods. The pixel signal PXS may be provided to the comparator 131.

The comparator 131 may include an amplifier AMP, a capacitor C, and an auto-zero switch SW_{AZ}. According to an embodiment, the amplifier AMP may be implemented as an operational transconductance amplifier (OTA). The auto-zero switch SW_{AZ} may be turned on and off in response to an auto-zero signal AZ perform an auto-zero operation. For example, the auto-zero switch SW_{AZ} may be turned on in response to the auto-zero signal AZ reaching an active level.

Referring to FIGS. 3 and 4 together, the auto-zero signal AZ may transition from an inactive level (e.g., logic low) to an active level (e.g., logic high) at the beginning of a read-out period RP, e.g., at a time point t0, and the auto-zero switch SW_{AZ} may be turned on in response to the auto-zero signal AZ at the active level to connect a first input terminal+(e.g., a non-inverting input terminal), a second input terminal−(e.g., an inverting input terminal), and an output terminal O of the amplifier AMP. Although FIG. 3 shows that the auto-zero switch SW_{AZ} is connected to the second input terminal−and the output terminal O for convenience of explanation, the inventive concept is not limited thereto, and another auto-zero switch SW_{AZ} may be connected to the first input terminal+and the internal output node of the comparator 131.

The offset of the amplifier AMP may be removed by an auto-zero operation. The voltages of the first input terminal+, the second input terminal−and the output terminal O may have the same voltage level (e.g., auto-zero level). An offset removal voltage for removing the offset of the amplifier AMP may be stored in the capacitor C.

The ramp signal V_{RAMP} provided by the ramp signal generator 140 may be applied to the first input terminal+of the amplifier AMP. The voltage of the first input terminal+(e.g., a first input voltage V_{INP)} may be equal to that of the ramp signal V_{RAMP}. According to an embodiment, a capacitor may be connected to the first input terminal+, and the ramp signal V_{RAMP} may be applied to the first input terminal+through the capacitor. The first input voltage V_{INP} may reflect the ramp signal V_{RAMP}, and the level of the first input voltage V_{INP} may be changed according to the change in the level of the ramp signal V_{RAMP}.

The pixel signal PXS may be applied to the second input terminal—of the amplifier AMP through the capacitor C. The voltage of the second input terminal—(e.g., a second input voltage V_{INN}) may reflect the pixel signal PXS, and the level of the second input voltage V_{INN} may be changed according to a change in the level of the pixel signal PXS.

The ramp signal generator 140 may generate the ramp signal V_{RAMP} whose level decreases (or increases) at a constant rate. Referring to FIG. 4, the ramp signal generator 140 may generate the ramp signal V_{RAMP} by adding an offset (e.g., an offset voltage V_{OFS)} to the reference ramp signal V_{RR}. The offset voltage V_{OFS} is a direct current (DC) voltage and may be either positive or negative.

After auto-zero is performed, the reference ramp signal V_{RR} may increase to the highest level LH1 at the time point t1. During a reset counting period (e.g., from a time point t2 to a time point t5), the reference ramp signal V_{RR} may decrease at a constant rate from the highest level LH1. Thereafter, the reference ramp signal V_{RR} may increase to the highest level LH1, and, during a signal counting period (e.g., a time point t6 to a time point t9), the reference ramp signal V_{RR} may decrease from the highest level LH1 at a constant rate. The highest level LH1 and the slope of the reference ramp signal V_{RR} may be determined (or changed) based on an analog gain AG. The smaller the analog gain AG, the steeper the slope of the reference ramp signal V_{RR} and the higher the highest level LH1. The larger the analog gain AG, the gentler the slope of the reference ramp signal V_{RR} and the lower the highest level LH1.

The ramp signal V_{RAMP} reflects the reference ramp signal V_{RR}, and the slope of the ramp signal V_{RAMP} is the same as the slope of the reference ramp signal V_{RR}. However, the level of the ramp signal V_{RAMP} may be higher or lower than the level of the reference ramp signal V_{RR} as much as the offset voltage V_{OFS}. For example, the highest level LH2 of the ramp signal V_{RAMP} may be higher than the highest level LH1 of the reference ramp signal V_{RR} by the offset voltage V_{OFS}.

The comparator 131 may compare the second input voltage V_{INN} with the first input voltage V_{INP} (e.g., the ramp signal V_{RAMP}) and output a comparison result signal as an output signal VOUT. The counter 132 may count the conversion time of the output signal VOUT based on a clock signal CLK.

The first input voltage V_{INP} may be equal to or reflect the ramp signal V_{RAMP}. During the reset counting period (e.g., from the time point t2 to the time point t5), the second input voltage V_{INN} may reflect a reset signal. At a time point t4 during the reset counting period, the second input voltage V_{INN} and the first input voltage V_{INP} (e.g., the ramp signal V_{RAMP}) become equal to each other, and the output signal VOUT (e.g., a first comparison result signal) may transition from a first level to a second level. The counter 132 may count the period from a reference time point (e.g., the time point t2) to a decision point (e.g., the time point t4) based on the clock signal CLK. For example, the counter 132 may count the number of toggles of the clock signal CLK during a period from the time point t2 to the time point t4 and generate a counted value (e.g., 3) as a reset value.

During the signal counting period (e.g., from the time point t6 to the time point t9), the second input voltage V_{INN} may reflect an image signal. At a time point t8 during the signal counting period, the second input voltage V_{INN} and the first input voltage V_{INP} (e.g., the ramp signal V_{RAMP}) become equal to each other, and the output signal VOUT, e.g., a second comparison result signal, may transition from a first level to a second level. The counter 132 may generate the number of toggles (e.g., 5) of the clock signal CLK from a reference time point (e.g., the time point t6) to a decision point (e.g., the time point t8) as a signal value. The counter 132 may calculate (generate) pixel data PXD by subtracting a reset value from a signal value.

When analog dithering is not applied, the reference ramp signal V_{RR} may be provided to the comparator 131 as the ramp signal V_{RAMP}. At a time point t3 during the reset counting period, the second input voltage V_{INN} and the first input voltage V_{INP} (e.g., the reference ramp signal V_{RR}) become equal to each other, and the output signal VOUT (e.g., a first comparison result signal) may transition from a first level to a second level. The counter 132 may count the number of toggles of the clock signal CLK during a period from the time point t2 to the time point t3 and generate a counted value (e.g., 2) as a reset value.

At a time point t7 during the signal counting period, the second input voltage V_{INN} and the first input voltage V_{INP} (e.g., the reference ramp signal V_{RR}) become equal to each other, and the output signal VOUT, e.g., a second comparison result signal, may transition from a first level to a second level. The counter 132 may count the number of toggles of the clock signal CLK during a period from the time point t6 to the time point t7 and generate a counted value (e.g., 4) as a signal value. The counter 132 may calculate (generate) a value (e.g., 2) obtained by subtracting a reset value from a signal value as the pixel data PXD.

A reset value and a signal value when analog dithering is not applied may be different from a reset value and a signal value when analog dithering is applied. However, depending on the level of the offset voltage V_{OFS} and/or pixel signal PXS, reset values or/and signal values when analog dithering is not applied and when analog dithering is applied may be the same.

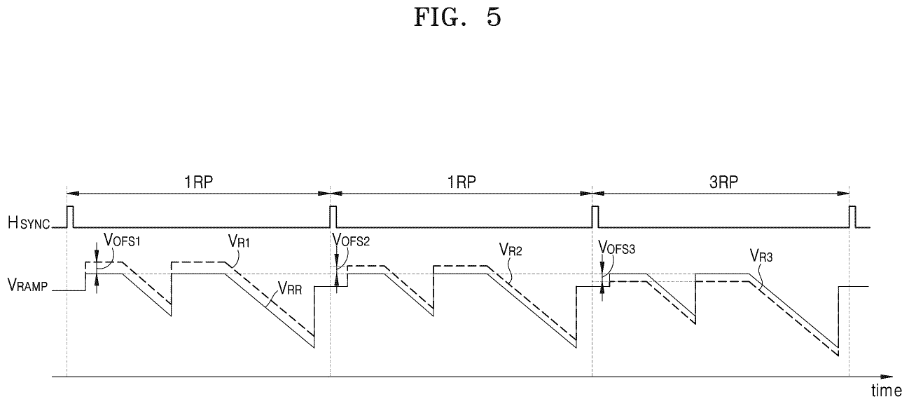

FIG. 5 is a diagram showing a ramp signal of an image sensor, according to an embodiment.

Referring to FIG. 5, a plurality of read-out periods (e.g., a first read-out period 1RP, a second read-out period 2RP, and a third read-out period 3RP) may be distinguished by a horizontal synchronization signal Hsync. For example, each of a plurality of read-out periods may correspond to a horizontal period distinguished by the horizontal synchronization signal Hsync.

The ramp signal generator (e.g., the ramp signal generator 140 of FIG. 1) may generate a first ramp signal V_{R1} by adding a first offset (e.g., a first offset voltage V_{OFS1}) to the reference ramp signal V_{RR} during the first read-out period 1RP, and may provide the first ramp signal V_{R1} as the ramp signal V_{RAMP} to the comparators (e.g., the comparators 131 of FIG. 1) of the ADC circuit (e.g., the ADC circuit 130 of FIG. 1).

The ramp signal generator 140 may generate a second ramp signal V_{R2} by adding a second offset (e.g., a second offset voltage V_{OFS2}) to the reference ramp signal V_{RR} during the second read-out period 2RP, which is continuous with the first read-out period 1RP, and provide the second ramp signal V_{R2} as the ramp signal V_{RAMP} to the comparators 131. The second offset voltage V_{OFS2} may be different from the first offset voltage V_{OFS1}.

The ramp signal generator 140 may generate a third ramp signal V_{R3} by adding a third offset (e.g., a third offset voltage V_{OFS3}) to the reference ramp signal V_{RR} during the third read-out period 3RP, which is continuous with the second read-out period 2RP, and provide the third ramp signal V_{R3} as the ramp signal V_{RAMP} to the comparators 131. The third offset voltage V_{OFS3} may be different from the second offset voltage V_{OFS2} and/or the first offset voltage V_{OFS1}. According to an embodiment, the third offset voltage V_{OFS3} may be a negative voltage.

In this regard, the ramp signal generator 140 may generate the ramp signal V_{RAMP} by adding an offset to the reference ramp signal V_{RR}, and the offset may be changed for each read-out period.

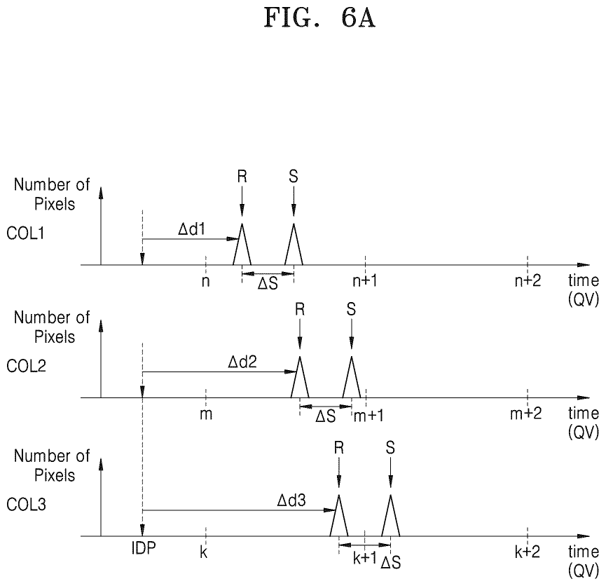

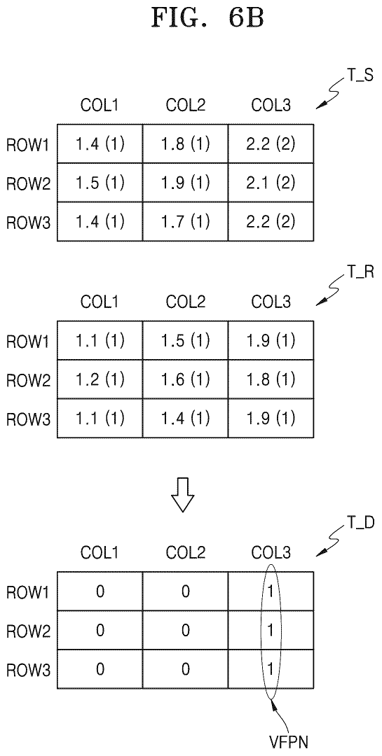

FIG. 6A is a diagram showing decision points of pixel signals for each column of a pixel array in a CDS operation to which analog dithering is not applied, according to an example embodiment, and FIG. 6B is a diagram showing decision points of pixel signals and quantization values for each column and row of a pixel array in a CDS operation to which analog dithering is not applied, according to an embodiment. FIGS. 6A and 6B show decision points and quantization values of pixel signals under dark conditions (or very weak illuminance conditions) in which no optical signal is input to an image sensor and when the analog gain is set to the lowest value (e.g., when the analog gain is set to 1).

Referring to FIG. 6A, the horizontal axis represents time and the vertical axis represents the number of pixels. A plurality of pixels arranged in different rows may be connected to each of a plurality of columns of a pixel array (e.g., a first column COL1, a second column COL2, and a third column COL3). A reset signal decision distribution R and an image signal decision distribution S represent the distribution of decision points of reset signals and the distribution of decision points of image signals, which are output the plurality of pixels in each column, respectively. A difference ΔS between the reset signal decision distribution R and the image signal decision distribution S may correspond to an actual pixel signal (pure pixel signal) according to an amount of charges generated from a photo diode.

Decision points of a reset signal and an image signal in each column may be delayed from an ideal decision point IDP of each column. A decision delay Δd1 of the first column COL1, a decision delay Δd2 of the second column col2, and a decision delay Δd3 of the third column COL3 may be different from one another. The difference between decision delays may be caused by differences in threshold voltage of transistors provided in the comparator 131 of FIG. 1, the gain error of a comparator, and the difference between bandwidths, and may vary depending on process/voltage/temperature (PVT) characteristics.

The reset signal decision point and the image signal decision point of a pixel may be respectively converted into quantization values (QV) (e.g., a reset value and a signal value). In the first column COL1, the reset signal decision distribution R and the image signal decision distribution S are distributed between n and n+1, and thus quantization values of reset signals and image signals, i.e., reset values and signal values, may all be n. In the second column COL2, the reset signal decision distribution R and the image signal decision distribution S are distributed between m and m+1, and thus quantization values of reset signals and image signals may all be m. In the third column COL3, the reset signal decision distribution R and the image signal decision distribution S are distributed between k and k+1, and thus the quantization value of reset signals may be k, and the quantization value of image signals may be k+1. Here, m, n, and k may each be an integer greater than or equal to 1.

Referring to FIG. 6B, a signal table T_S and a reset table T_R represent image signal decision points and the reset signal decision points for each column and row of a pixel array, respectively, and the numbers in parentheses represent quantization values (reset values and signal values). For convenience of explanation, it is assumed that the pixel array includes pixels arranged in a 3×3 matrix.

In the signal table T_S and the reset table T_R, a decision point is represented by a number corresponding to a quantization value, and the unit of the number may be the least significant bit (LSB) indicating the minimum change in the quantization value. A data table T_D represents pixel values obtained by subtracting reset values of the reset table T_R from signal value of a signal table T_S for each column and row corresponding to the pixel array, and corresponds to image data.

In the signal table T_S and the reset table T_R, the quantization values (signal values and reset values) of the first column COL1 and the second column COL2 are all 1 LSB, and thus, in the data table T_D, pixel values of the first column COL1 and the second column COL2 are both 0 LSB.

However, all quantization values (signal values) of the third column COL3 in the signal table T_S are 2, and all quantization values (reset values) of the third column COL3 in the reset table T_R are 1. Therefore, all pixel values of the third column COL3 in the data table T_D are calculated as 1.

In each column, an actual pixel value corresponding to the difference between an image signal decision point and a reset signal decision point is constantly 0.3 LSB, but quantization results are different due to the difference in decision delay. Ideally, the pixel values of the third column COL3 should be output as 0 LSB since an actual signal 0.3 LSB is smaller than 1 LSB, but the pixel values are output as 1 LSB due to quantization error.

In the third column COL3, since pixel values of first to third rows ROW1, ROW2, and ROW3 are different from pixel values of the first column COL1 and the second column COL2, a VFPN in which a vertical line corresponding to the third column COL3 in image data appears brighter than the surrounding area may occur. In this regard, under dark conditions (or weak illuminance conditions), VFPN may occur when the average value of pixel values of a particular column differs significantly from the average value of pixel values of the surrounding columns.

Meanwhile, in FIG. 6A, the smaller the variations of the reset signal decision distribution R and the image signal decision distribution S, the larger the quantization noise, which increases the visibility of the VFPN. Also, the larger the variations of the reset signal decision distribution R and the image signal decision distribution S, the smaller the quantization noise may be, and, as the randomness of the quantization noises increase, the visibility of the VFPN may decrease.

The smaller the analog gain, the steeper the slope of the ramp signal (V_{RAMP} of FIG. 1), resulting smaller variations in the reset signal decision distribution R and the image signal decision distribution S. Meanwhile, the larger the analog gain, the gentler the slope of the ramp signal V_{RAMP}, which may increase the variations in the reset signal decision distribution R and the image signal decision distribution S. Therefore, when the analog gain is set small, the visibility of the VFPN in image data may be increased. Therefore, as described above with reference to FIG. 1, when the analog gain is lower than or equal to a reference value, the ramp signal generator 140 may generate the ramp signal V_{RAMP} including an offset that varies for each read-out period. However, when the analog gain is greater than the reference value, the ramp signal generator 140 may generate the same ramp signal V_{RAMP} for each read-out period without including an offset.

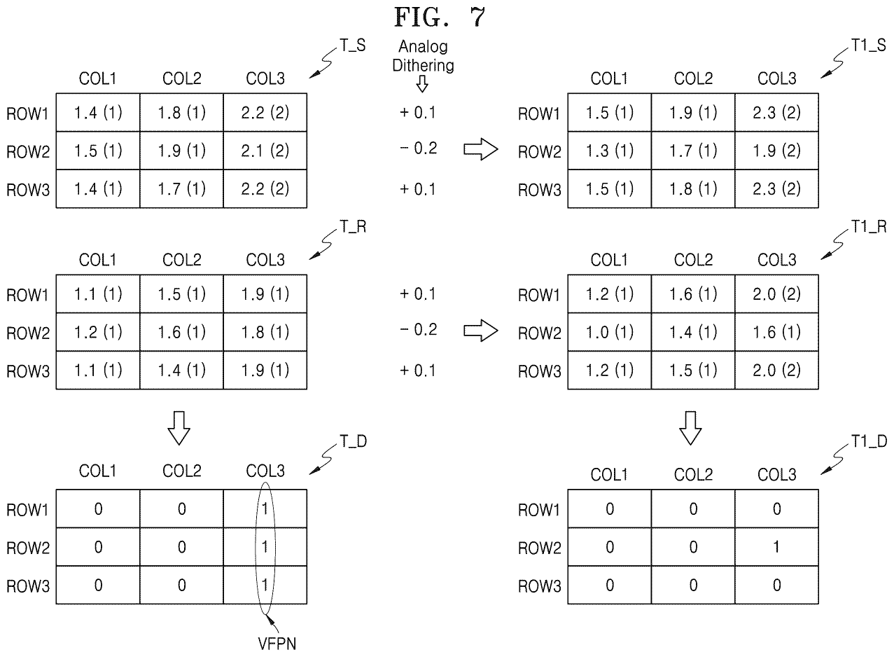

FIG. 7 is a diagram showing decision points and quantization values of pixel signals for each column and row of a pixel array in a CDS operation with analog dithering applied according to an embodiment.

A signal table T1_S and a reset table T1_R represent image signal decision points and reset signal decision points according to the application of analog dithering according to an embodiment to the signal table T_S and the reset table T_R of FIG. 6B, respectively. A data table T1_D represents pixel values obtained by subtracting reset values of the reset table T1_R from signal values of the signal table T1_S.

As described above with reference to FIGS. 4 and 5, the ramp signal V_{RAMP} includes an offset, and the offset may vary for each of a plurality of read-out periods. According to the offset, the decision points of image signals and reset signals may vary.

It is assumed that, through the analog dithering, decision points of an image signal and a reset signal of the first column COL1 increase (or are delayed) by 0.1 LSB, decision points of an image signal and a reset signal of the second column COL2 decrease (or advance) by 0.2 LSB, and decision points of an image signal and a reset signal of the third column COL3 increase by 0.1 LSB.

In a signal table T1_S, signal values of the first column COL1 and the second column COL2 are 1 LSB, and signal values of the third column COL3 is 2 LSB. In a reset table T1_R, reset values of the first column COL1 and the second column COL2 are 1 LSB, reset values of a first row ROW1 and a second row ROW2 of the third column COL3 are 2 LSB, and a reset value of the second row ROW2 is 1 LSB.

Pixel values of the data table T1_D are calculated based on signal values of the signal table T1_S and reset values of the reset table T1_R. In the data table T1_D, pixel values of the first column COL1 and the second column COL2 are all 0 LSB. Reset values of the first row ROW1 and the second row ROW2 of the third column COL3 are 0 LSB, and a reset value of the second row ROW2 is 1 LSB. Since analog dithering is applied to the CDS operation, some of pixel values of the third column COL3 may be identical to pixel values of surrounding columns, unlike when analog dithering is not applied. The VFPN of image data may be reduced because the difference between an average value of pixel values of the third column COL3 and an average value of pixel values of the surrounding columns is reduced.

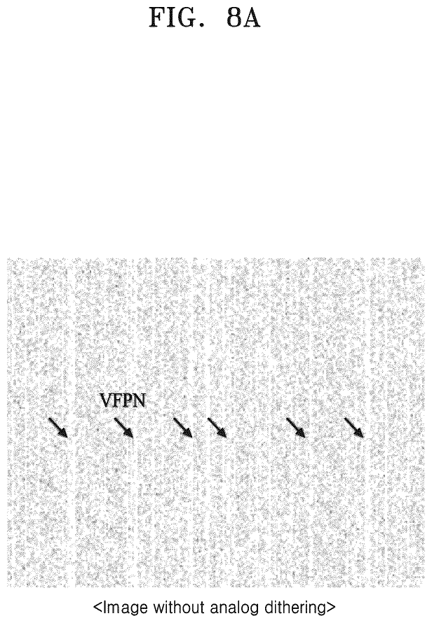

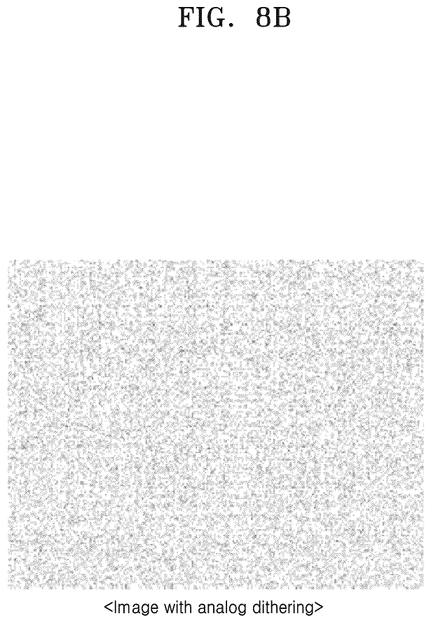

FIGS. 8A and 8B are diagrams showing images generated under dark conditions.

FIG. 8A shows an image generated when analog dithering is not applied to a CDS operation according to a comparative example, and FIG. 8B shows an image generated when analog dithering is applied to a CDS operation according to an embodiment.

In FIG. 8A, in an image generated when analog dithering is not applied to the CDS operation, the VFPN in which a particular column appears brighter than the surrounding columns may occur. However, when analog dithering is applied to the CDS operation according to an embodiment in FIG. 8B, the VFPN may not occur in an image or the VFPN may be reduced.

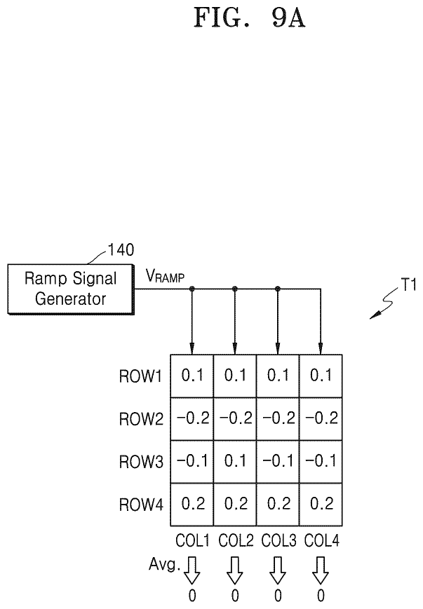

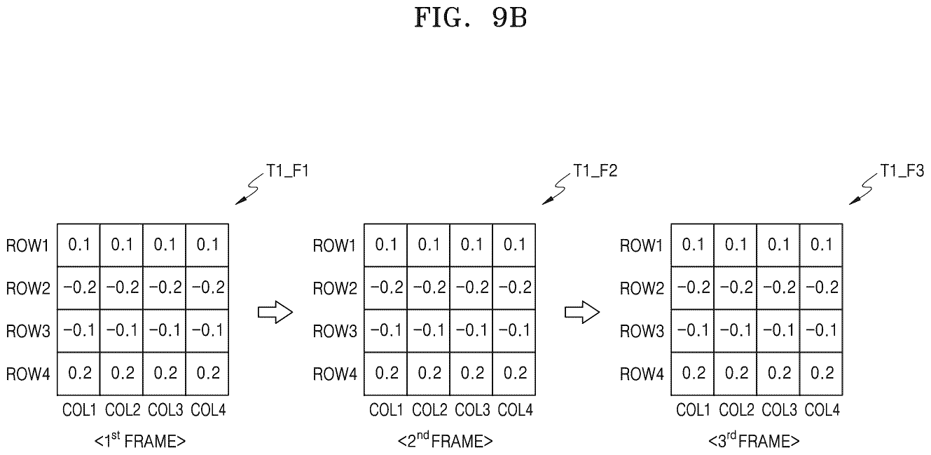

FIGS. 9A and 9B are diagrams showing an analog dithering method according to an embodiment.

As described above, the ramp signal V_{RAMP} generated by the ramp signal generator 140 may include an offset (offset voltage), and the offset may be changed for each read-out period.

The numbers in a table T1 of FIG. 9A represent signal offsets applied to each column and row of the pixel array (110 of FIG. 1) according to an offset included in the ramp signal V_{RAMP} in each read-out period. In other words, the numbers of the table T1 represent signal offsets applied to pixel signals output from the pixel array 110 for each column and each row of the pixel array 110. For example, decision delay points of pixel signals (reset signals and image signals) may be increased (delayed) or decreased (advanced) depending on the above-stated numbers. The units of the above-stated numbers may be LSB. It is assumed that the pixel array 110 includes a plurality of pixels arranged in a 4×4 matrix.

The ramp signal V_{RAMP} may be commonly provided to the plurality of comparators (131 of FIG. 1) of the ADC circuit (130 of FIG. 1), and thus signal offsets applied to a plurality of columns in each row (e.g., first to fourth columns COL1 to COL4) are the same. As described above with reference to FIG. 5, an offset applied to the ramp signal V_{RAMP} may be a positive voltage or a negative voltage, and a signal offset applied to the pixel array 110 may also have a positive value or a negative value.

Meanwhile, the average value of signal offsets of each column may be 0 LSB. An offset included in the ramp signal V_{RAMP} in each read-out period may be determined, such that an average value of signal offsets of each column of the pixel array 110 becomes 0 LSB. For example, the sum of offsets included in the ramp signal V_{RAMP} over a plurality of read-out periods may ‘0’.

Tables T1_F1, T1_F2, and T1_F3 of FIG. 9B represent signal offsets applied to each column and row of the pixel array 110 for each frame. To prevent horizontal noise, signal offsets applied to the rows of the pixel array 110 in a first frame, a second frame, and a third frame may be the same.

As shown in FIG. 4, offsets included in the ramp signal V_{RAMP} in a reset counting period and a signal counting period are the same, and a signal offset may ideally be removed through a CDS operation. However, the signal offset may partially remain, resulting in horizontal noise. For example, when 0.1 LSB is applied to the first column COL1 of the first frame as a signal offset and 0.2 LSB is applied to the first column COL1 of the second frame, horizontal noise may occur. To prevent such horizontal noise, the same signal offset may be applied to the same row for each frame. In other words, the ramp signal V_{RAMP} may include the same offset during same read-out period of every frame.

For example, setting values of an offset included in the ramp signal V_{RAMP} for each read-out period may be stored in a register of the ramp signal generator 140 or a separate register, and for each read-out period, the ramp signal generator 140 may generate an offset based on setting values set for a corresponding read-out period. Also, the ramp signal generator 140 may generate an offset corresponding to each read-out period based on the setting values for each frame. Therefore, the same signal offset may be applied to the same row of each frame.

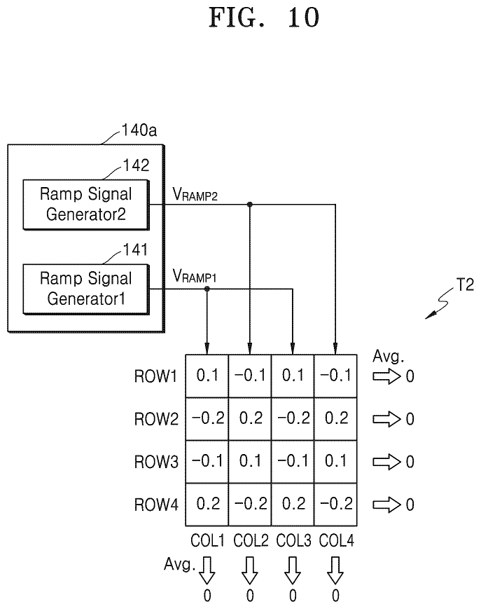

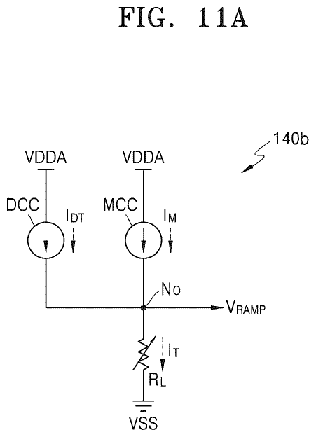

FIG. 10 is a diagram showing an analog dithering method according to an embodiment.

A table T2 of FIG. 10 represents signal offsets applied to columns and rows of the pixel array 110, and, to prevent horizontal noise, a signal offset applied to odd columns (e.g., the first column COL1 and the third column COL3) of the pixel array 110 and a signal offset applied to even columns (e.g., the second column COL2 and a fourth column COL4) may have the same magnitude and opposite signs. For example, a signal offset of 0.1 LSB may be applied to the first column COL1 and the third column COL3 of the first row ROW1, and a signal offset of-0.1 LSB may be applied to the second column COL2 and the fourth column COL4 of the first row ROW1.

Therefore, the average value of signal offsets of each row may be 0 LSB. Also, as described with reference to FIG. 9A, the average value of signal offsets of each column may be 0 LSB.

To apply different offsets to odd columns and even columns of the pixel array 110, from among the plurality of comparators 131 of the ADC circuit (e.g., the ADC circuit 130 of FIG. 1), a comparator connected to an odd column of the pixel array 110 (e.g., a comparator that receives a pixel signal through a column line CL connected to an odd column of the pixel array 110 from among the plurality of column lines CL, hereinafter referred to as a first comparator) and a comparator connected to an even column of the pixel array 110 (e.g., a comparator that receives a pixel signal through a column line CL of the pixel array 110 from among the plurality of column lines CL, hereinafter referred to as a second comparator) may operate based on different ramp signals.

To this end, a ramp signal generator 140a may include a first ramp signal generator 141 and a second ramp signal generator 142, and the first ramp signal generator 141 and the second ramp signal generator 142 may generate a first ramp signal V_{RAMP1} and a second ramp signal V_{RAMP2}, respectively.

The first ramp signal generator 141 may generate the first ramp signal V_{RAMP1} by adding a first offset to a reference ramp signal, and the second ramp signal generator 142 may generate the second ramp signal V_{RAMP2} by adding a second offset to the reference ramp signal. The first offset and the second offset may have the same magnitude and opposite symbols. For example, when the first offset is a positive offset voltage corresponding to 0.1 LSB (e.g., 0.1 times the unit change amount of the reference ramp signal), the second offset may be a negative offset voltage corresponding to-0.1 LSB, and the absolute value of the positive offset voltage and the absolute value of the negative offset voltage may be the same.

The ramp signal generator 140a may provide the first ramp signal V_{RAMP1} to a plurality of first comparators and the second ramp signal V_{RAMP2} to a plurality of second comparators. Therefore, a signal offset applied to odd columns of the pixel array 110 and a signal offset applied to even columns of the pixel array 110 may have the same magnitude and opposite symbols, and the average value of signal offsets of each row may be 0 LSB.

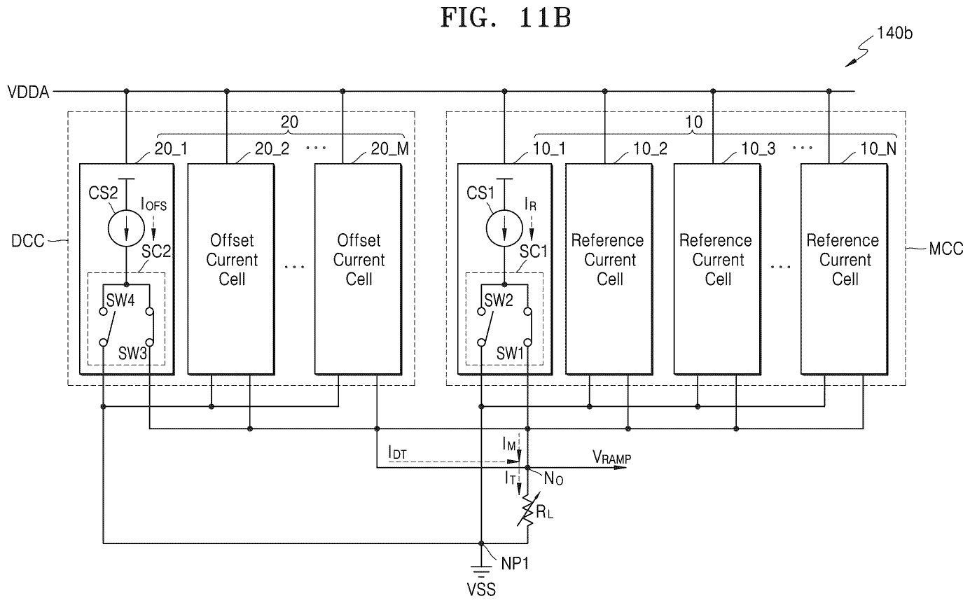

FIGS. 11A and 11B are diagrams showing a ramp signal generator according to an embodiment.

Referring to FIG. 11A, a ramp signal generator 140b may include a main current source MCC, a dithering current source DCC, and a load resistor R_{L}. The ramp signal generator 140b may further include a bias circuit that provides bias voltages to the main current source MCC and the dithering current source DCC.

The main current source MCC may generate a main current I_{M} for generating a reference ramp signal, and the dithering current source DCC may generate a dithering current I_{DT} for generating an offset (offset voltage). The main current source MCC and the dithering current source DCC may generate the main current I_{M} and the dithering current I_{DT} based on a first power voltage VDDA (e.g., an analog power voltage) applied to one end of each of the main current source MCC and the dithering current source DCC.

A first end of the load resistor R_{L} is connected to an output node N_{O}, and a second power voltage VSS may be applied to a second end of the load resistor R_{L}. The second power voltage VSS may be a ground voltage, and may be lower than the first power voltage VDDA.

The load resistor R_{L} is a variable resistor, and the resistance value of the load resistor R_{L} may be changed according to an analog gain. As the analog gain decreases, the resistance value of the load resistor R_{L} may increase. As the analog gain increases, the resistance value of the load resistor R_{L} may decrease. For example, the resistance value of the load resistor R_{L} when the analog gain is 16 may be 1/16 times the resistance value of the load resistor R_{L} when the analog gain is 1.

The main current I_{M} and the dithering current I_{DT} are provided to the load resistor R_{L}, wherein a reference ramp signal may be generated by the main current I_{M}, and an offset (offset voltage) may be generated by the dithering current I_{DT}.

The level of a reference ramp signal is determined based on the resistance value of the load resistor R_{L} and an amount of current of the main current I_{M}. During a read-out period, the main current I_{M} may be reduced at a constant rate in units of a reference current, and thus a slope of the level of the reference ramp signal may be formed. The unit change of the reference ramp signal (or ramp signal) may correspond to the least significant bit (LSB) of a quantized value (e.g., pixel data).

The dithering current I_{DT} is constant during one read-out period and may vary over a plurality of read-out periods. The offset (offset voltage) may be determined based on a resistance value of the load resistor R_{L} and an amount of the dithering current I_{DT}.

A total current I_{T} including the main current I_{M} and the dithering current I_{DT} is provided to the load resistor R_{L}, and a reference ramp signal and an offset are added at a first end (or the output node N_{O}) of the load resistor R_{L} to generate the ramp signal V_{RAMP}. A first end of the load resistor R_{L} is connected to the output node N_{O}, and the ramp signal V_{RAMP} may be output from the output node N_{O}.

Referring to FIG. 11B, the main current source MCC includes a plurality of reference current cells 10 (e.g., first to N-th reference current cells 10_1 to 10_N, wherein N is an integer greater than or equal to 4). Each of the first to N-th reference current cells 10_1 to 10_N generates a reference current I_{R} (or referred to as a cell current), and the sum of reference currents I_{R} output from the reference current cells 10 that are in an on state from among the first to N-th reference current cells 10_1 to 10_N corresponds to the main current I_{M}. Here, a reference current cell 10 being in the on state indicates that the reference current I_{R} generated by the reference current cell 10 is provided to the load resistance R_{L}, and the reference current cell 10 being in the off state indicates that the reference current I_{R} generated by the reference current cell 10 is provided to a first power node NP1 (e.g., ground) rather than the load resistor R_{L}.

The first to N-th reference current cells 10_1 to 10_N may be turned on before a reset counting period starts (e.g., before the time point t2 of FIG. 4) and before a signal counting period starts (e.g., before the time point t6 of FIG. 4) during a read-out period, and the first to N-th reference current cells 10_1 to 10_N may be sequentially turned off one-by-one during the reset counting period and the signal counting period. Therefore, during the reset counting period and the signal counting period, the main current I_{M} may decrease at a constant rate in units of the reference current I_{R}, and the level of a reference ramp signal may decrease at a constant rate. A value (e.g., unit voltage) obtained by multiplying the resistance of the load resistor R_{L} by the reference current I_{R} may correspond to a unit change in the reference ramp signal (e.g., a change corresponding to 1 LSB). Hereinafter, the unit voltage is expressed as 1 LSB.

The first to N-th reference current cells 10_1 to 10_N may each include a first current source CS1 and a first selection circuit SC1. The first current source CS1 may generate the reference current I_{R}.

The first selection circuit SC1 may provide the reference current I_{R} to the load resistor RL or to the first power node NP1 to which the second power voltage VSS is applied. The first selection circuit SC1 may include a first switch SW1 and a second switch SW2 that operate complementarily. When the first switch SW1 is turned on, the second switch SW2 is turned off, and, when the first switch SW1 is turned off, the second switch SW2 is turned on. The first switch SW1 may be turned on to provide the reference current I_{R} to the load resistor R_{L}, and the second switch SW2 may be turned on to provide the reference current I_{R} to the first power node NP1 to which the second power voltage VSS is applied. When the reference current cell 10 is turned on, the first switch SW1 may be turned on to provide the reference current I_{R} to the load resistor R_{L}, and, when the reference current cell 10 is turned off, the second switch SW2 may be turned on to provide the reference current I_{R} to the first power node NP1.

The dithering current source DCC may include a plurality of offset current cells 20, including first to M-th offset current cells 20_1 to 20_M (M is an integer greater than or equal to 2). Each of the first to M-th offset current cells 20_1 to 20_M generates an offset current I_{OFS}, and the sum of offset currents I_{OFS} output from the offset current cells 20 in an on state from among the first to M-th offset current cells 20_1 to 20_M corresponds to the dithering current I_{DT}. Here, an offset current cell 20 being in the on state indicates that the offset current I_{OFS} generated by the offset current cell 20 is provided to the load resistor R_{L}, and the offset current cell 20 being in an off state indicates that the offset current I_{OFS} generated by the offset current cell 20 is provided to the first power node NP1 rather than the load resistor R_{L}.

According to an embodiment, the offset current I_{OFS} may be less than or equal to the reference current I_{R}. The offset current I_{OFS} may be 1/R times the reference current I_{R} (I_{OFS}=I_{R}/R, where R is a real number greater than or equal to 1). When K offset current cells 20 (K is an integer greater than or equal to 1 and less than or equal to M) from among the first to M-th offset current cells 20_1 to 20_M are turned on, the sum of the offset currents I_{OFS} output from the K offset current cells 20 in the on state (e.g., the dithering current IDT) may be K/R times the reference current I_{R} (I_{DT}=I_{OFS}×K=(I_{R}/R)×K). The product of the sum of the offset currents I_{OFS} (e.g., the dithering current I_{DT}) multiplied by the resistance of the load resistor R_{L} (e.g., K/R times the unit change in the reference ramp signal) corresponds to the offset of the ramp signal V_{RAMP}. The offset may correspond to K/R times 1 LSB (=K/R×LSB). By changing the number (e.g., K) of the offset current cells 20 in the on state for each read-out period, the offset of the ramp signal V_{RAMP} may be changed for each read-out period.

When one offset current cell 20 from among the first to M-th offset current cells 20_1 to 20_M is in the on state (e.g., K=1), the offset current I_{OFS} (e.g., the minimum value of the dithering current I_{DT}) output from the one offset current cell 20 in the on state is 1/R times the reference current I_{R} and may be smaller than or equal to the reference current I_{R}. The minimum value of the offset corresponds to 1/R×LSB, and may be less than or equal to 1 LSB.

When all of the first to M-th offset current cells 20_1 to 20_M are in the on state(e.g., K=M), the sum of M offset currents I_{OFS} output from the first to M-th offset current cells 20_1 to 20_M (e.g., the maximum value of the dithering current I_{DT}) is M/R times the reference current I_{R} (=I_{OFS}×M=(I_{R}/R)×M), and the maximum value of the offset may correspond to M/R×LSB.

According to an embodiment, R may be M. The maximum value of the dithering current IDT may be equal to the reference current I_{R}, and thus the maximum value of the offset may correspond to 1 LSB.

According to an embodiment, R may be greater than M. The maximum value of the dithering current I_{DT} (e.g., M/R ×I_{R}) may be less than the reference current I_{R}. The maximum value of the offset (e.g. M/R ×LSB) may be less than 1 LSB. For example, when R is 2×M, the maximum value of the dithering current I_{DT} (e.g., M/(2×M)×I_{R}) may be 0.5 times the reference current I_{R}. The maximum value of the offset (e.g. M/(2×M)×LSB) may be 0.5 LSB.

According to an embodiment, R may be smaller than M. The maximum value of the dithering current I_{DT} (e.g., M/R×I_{R}) may be greater than the reference current I_{R}. The maximum value of the offset (e.g. M/R×LSB) may be greater than 1 LSB. For example, when R is M/3, the maximum value of the dithering current I_{DT} (e.g., M/(M/3)×I_{R}) may be 3 times the reference current I_{R}. The maximum value of the offset (e.g. M/(M/3)×LSB) may be 3 LSB. The first to M-th offset current cells 20_1 to 20_M may each include a second current source CS2 and a second selection circuit SC2. The second current source CS2 may generate the offset current I_{OFS}.

The second selection circuit SC2 may provide the offset current I_{OFS} to the load resistor RL or to the first power node NP1. The second selection circuit SC2 may include a third switch SW3 and a fourth switch SW4 that operate complementarily. The third switch SW3 may be turned on to provide the offset current I_{OFS} to the load resistor R_{L}, and the fourth switch SW4 may be turned on to provide the offset current I_{OFS} to the first power node NP1. When the offset current cell 20 is turned on, the third switch SW3 may be turned on to provide the offset current I_{OFS} to the load resistor R_{L}, and, when the offset current cell 20 is turned off, the fourth switch SW4 may be turned on to provide the offset current I_{OFS} to the first power node NP1.

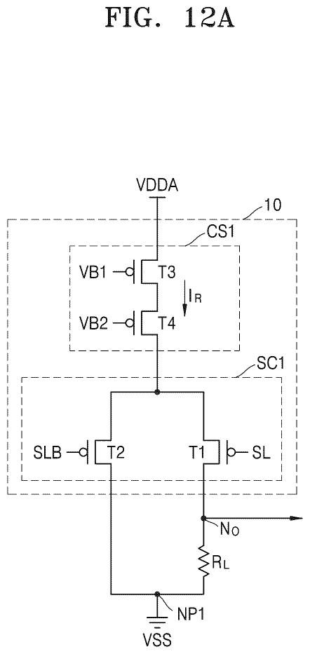

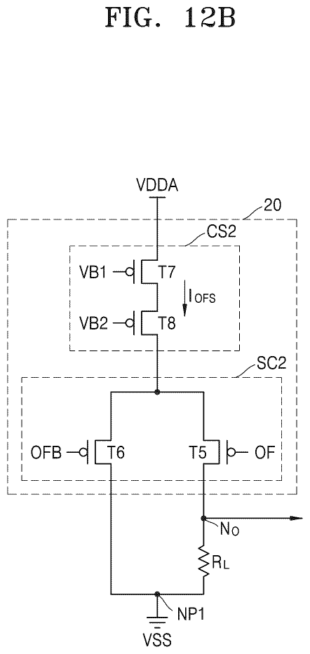

FIG. 12A is a diagram showing the reference current cell 10 of FIG. 11B, and FIG. 12B is a diagram showing shows the offset current cell 20 of FIG. 11B.

Referring to FIGS. 12A and 11B, the reference current cell 10 may include the first selection circuit SC1 and the first current source CS1, the first selection circuit SC1 may include a first transistor T1 and a second transistor T2, and the first current source CS1 may include a third transistor T3 and a fourth transistor T4.

First to fourth transistors T1 to T4 may be implemented as PMOS transistors (e.g., P-type metal oxide semiconductor field effect transistors (MOSFET)). However, the inventive concept is not limited thereto, and the first to fourth transistors T1 to T4 may be implemented as NMOS transistors (e.g., N-type MOSFET).

The first transistor T) and the second transistor T2 may correspond to the first switch SW1 and the second switch SW2 of FIG. 11B, respectively. The first transistor T1 and the second transistor T2 may each be turned on and off in response to an on control signal SL and an off control signal SLB. The off control signal SLB is the complementary signal of the on control signal SL. The first transistor T1 may be turned on in response to an active level (e.g., logic low) of the on control signal SL and may be turned off in response to an inactive level (e.g., logic high) of the on control signal SL. The second transistor T2 may be turned on in response to an active level (e.g., logic low) of the off control signal SLB and may be turned off in response to an inactive level (e.g., logic high) of the off control signal SLB.

The first selection circuit SC1 has a structure in which the third transistor T3 and the fourth transistor T4 are stacked, and the third transistor T3 and the fourth transistor T4 may generate the reference current I_{R} based on a first bias voltage VB1 and a second bias voltage VB2. The third transistor T3 corresponds to a bias stage and may generate the reference current I_{R} in a current mirroring manner based on the first bias voltage VB1 received from a bias circuit. The fourth transistor T4 corresponds to a cascode stage, and the second bias voltage VB2 may be a cascode voltage. The fourth transistor T4 may determine a direct current (DC) operating voltage of the reference current cell 10.

In FIG. 11B, the first bias voltage VB1 and the second bias voltage VB2 are uniformly provided to a plurality of reference current cells 10_1 to 10_N, and the on control signal SL and the off control signal SLB provided to each of the plurality of reference current cells 10_1 to 10_N may be different. The ramp signal generator 140b may further include a bias circuit and a control circuit, and the first bias voltage VB1 and the second bias voltage VB2 generated by the bias circuit may be provided to the plurality of reference current cells 10_1 to 10_N. The control circuit may generate a plurality of on control signals SL having different timings for transition from an active level to an inactive level and a plurality of off control signals SLB which are complementary signals of the plurality of on control signals SL. For example, the control circuit may generate a reference on control signal that transitions from an active level to an inactive level and a reference off control signal that transitions from the inactive level to an active level, and may sequentially delay the reference on control signal and the reference off control signal by a predetermined unit (e.g., one toggling period of a clock signal) to generate the plurality of on control signals SL and the plurality of off control signals SLB. The plurality of on control signals SL and the plurality of off control signals SLB may each be provided to the plurality of reference current cells 10_1 to 10_N.

Referring to FIG. 12B and FIG. 11B, the offset current cell 20 may include the second selection circuit SC2 and the second current source CS2, the second selection circuit SC2 may include a fifth transistor T5 and a sixth transistor T6, and the second current source CS2 may include a seventh transistor T7 and an eighth transistor T8.

The fifth transistor T5 and the sixth transistor T6 may correspond to the third switch SW3 and the second switch SW4 of FIG. 11B, respectively. The fifth transistor T5 and the sixth transistor T6 may each be turned on and off in response to an offset control signal OF and an offset control bar signal OFB. The offset control bar signal OFB is the complementary signal of the offset control signal OF. The fifth transistor T5 may be turned on in response to an active level (e.g., logic low) of the offset control signal OF, and the sixth transistor T6 may be turned on in response to an active level (e.g., logic low) of the offset control bar signal OFB.

The second current source CS2 has a structure in which the seventh transistor T7 and the eighth transistor T8 are stacked, and the seventh transistor T7 and the eighth transistor T8 may generate the offset current I_{OFS} based on the first bias voltage VB1 and the second bias voltage VB2. The seventh transistor T7 corresponds to a bias stage and may generate the offset current I_{OFS} in a current mirroring manner based on the first bias voltage VB1 received from a bias circuit. The eighth transistor T8 corresponds to a cascode stage and may determine a direct current (DC) operating voltage of the offset current cell 20.

As described above with reference to FIG. 11B, the offset current I_{OFS} is smaller than the reference current I_{R} generated by the reference current cell 10. The offset current I_{OFS} may be 1/R times the reference current I_{R}. To this end, the size of the seventh transistor T7 may be 1/R times the size of the third transistor T3 of the reference current cell 10.

In FIG. 11B, the first bias voltage VB1 and the second bias voltage VB2 are uniformly provided to the plurality of offset current cells 20_1 to 20_M, and an offset control signal OF and the offset control bar signal OFB provided to each of the plurality of offset current cells 20_1 to 20_M may be different. A control circuit may generate a plurality of offset control signals OF and a plurality of offset control bar signals OFB based on offset setting value set for each read-out period (or the pixel array 110 that outputs a pixel signal in a corresponding read-out period) and provide the plurality of offset control signals OF and the plurality of offset control bar signals OFB to corresponding offset current cells 20, respectively.

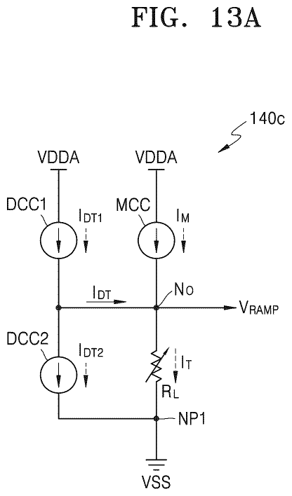

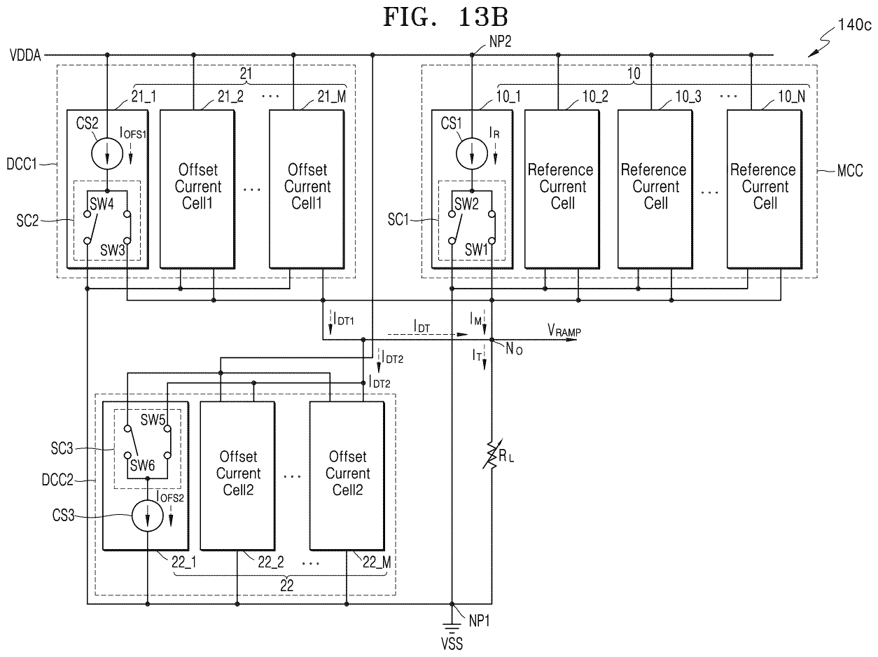

FIGS. 13A and 13B are diagrams showing a ramp signal generator according to an embodiment.

Referring to FIG. 13A, a ramp signal generator 140c may include the main current source MCC, a first dithering current source DCC1, a second dithering current source DCC2, and the load resistor R_{L}. The ramp signal generator 140c may further include a bias circuit that provides bias voltages to the main current source MCC, the first dithering current source DCC1, and the second dithering current source DCC2.

The configuration and the operation of the ramp signal generator 140c are similar to the configuration and the operation of the ramp signal generator 140b of FIGS. 11A and 11B. Therefore, descriptions will focus on differences therebetween.

Compared with the ramp signal generator 140b of FIG. 11A, the ramp signal generator 140c may further include the second dithering current source DCC2. The configuration and the operation of the first dithering current source DCC1 may be substantially identical to those of the dithering current source DCC of the ramp signal generator 140b of FIGS. 11A and 11B.

The first dithering current source DCC1 may generate a first dithering current I_{DT1}, and the second dithering current source DCC2 may generate a second dithering current I_{DT2}. The second dithering current source DCC2 may generate the second dithering current I_{DT2} based on the second power voltage VSS applied to one end of the second dithering current source DCC2. The main current I_{M} and the first dithering current I_{DT1} may be positive currents, and the second dithering current I_{DT2} may be a negative current. In other words, the first dithering current I_{DT1} is added to the main current I_{M}, whereas the second dithering current I_{DT2} is subtracted from the main current I_{M}. A positive offset (positive offset voltage) may be generated by the first dithering current I_{DT1}, and a negative offset (negative offset voltage) may be generated by the second dithering current I_{DT2}.

According to an embodiment, when the first dithering current source DCC1 operates, the second dithering current source DCC2 may be turned off, and, when the second dithering current source DCC2 operates, the first dithering current source DCC1 may be turned off. For example, in the first read-out period 1RP and the second read-out period 2RP of FIG. 5, a positive offset voltage is added to the reference ramp signal V_{RR}, and, in the third read-out period 3RP, a negative offset voltage is added to the reference ramp signal. During the first read-out period 1RP and the second read-out period 2RP, the first dithering current source DCC1 may generate the first dithering current I_{DT1}, and, during the third read-out period 3RP, the second dithering current source DCC2 may generate the second dithering current I_{DT2}.

Referring to FIG. 13B, the first dithering current source DCC1 may include a plurality of positive offset current cells 21 (or offset current cells 1), including, first to M-th positive offset current cells 21_1 to 21_M. Each of the first to M-th positive offset current cells 21_1 to 21_M may generate a first offset current I_{OFS1}. The sum of first offset currents I_{OFS1} output from the positive offset current cells 21 in an on state from among the first to M-th positive offset current cells 21_1 to 21_M corresponds to the first dithering current I_{DT1}. The offset current cells 20 described above with reference to FIG. 12B may be applied as the positive offset current cells 21. According to an embodiment, the first offset current I_{OFS1} may correspond to 1/R times the reference current I_{R}, the minimum value of the second dithering current I_{DT1} may correspond to 1/R times the reference current I_{R}, and the maximum value of the first dithering current I_{DT1} may correspond to M/R times the reference current I_{R}. The minimum value of a first offset (e.g., a positive offset) according to the first dithering current I_{DT1} may correspond to 1/R×LSB, and the maximum value of the first offset may correspond to M/R×LSB.

The second dithering current source DCC2 may include a plurality of negative offset current cells 22 (or offset current cells 2), including first to M-th negative offset current cells 22_1 to 22_M. The number of plurality of negative offset current cells 22 may be equal to the number of plurality of positive offset current cells 21. However, the inventive concept is not limited thereto, and the number of the plurality of negative offset current cells 22 may be different from the number of the plurality of positive offset current cells 21.

Each of the first to M-th negative offset current cells 22_1 to 22_M may generate a second offset current I_{OFS2}. The sum of second offset currents I_{OFS2} output from the negative offset current cells 22 in an on state from among the first to M-th negative offset current cells 22_1 to 22_M corresponds to the second dithering current I_{DT2}. Here, the on state of the negative offset current cell 20 indicates that the second offset current I_{OFS2} generated by the negative offset current cell 20 is provided from the main current source MCC, and the off state of the negative offset current cell 20 indicates that the second offset current I_{OFS2} is provided from a second power node NP2 (e.g., the first power voltage VDDA).

According to an embodiment, the second offset current I_{OFS2} may be less than or equal to the reference current I_{R}. According to an embodiment, the second offset current I_{OFS2} may be equal to the first offset current I_{OFS1}. The second offset current I_{OFS2} may be 1/R times the reference current I_{R} (I_{OFS2}=I_{R}/R). When K negative offset current cells 22 from among the first to M-th negative offset current cells 22_1 to 22_M are turned on, the sum of the offset currents I_{OFS} output from the K negative offset current cells 22 in the on state (e.g., the second dithering current I_{DT2}) may be K/R times the reference current I_{R} (I_{DT2}=I_{OFS2}×K=(I_{R}/R)×K). Since the second dithering current IDT2 is s_{DT2}racted from the main current IM, the second offset (negative offset) according to the second dithering current I_{DT2} may correspond to −K/R times 1 LSB (=−K/R×LSB). By changing the number (e.g., K) of the negative offset current cells 22 in the on state for each read-out period, the negative offset of the ramp signal V_{RAMP} may be changed.

The minimum value of the second dithering current I_{DT2} is 1/R times the reference current I_{R}, and may be less than or equal to the reference current I_{R}. The maximum value of the second dithering current I_{DT2} may correspond to M/R times the reference current I_{R}. The minimum value of the magnitude of a second offset (e.g., negative offset) according to the second dithering current I_{DT2} may correspond to 1/R×LSB, and the maximum value of the magnitude of the second offset may correspond to M/R×LSB. For example, when R is equal to M, the maximum value of the magnitude of the second offset may correspond to 1 LSB. For example, when R is greater than M, the maximum magnitude of the second offset may be less than 1 LSB. For example, when R is smaller than M, the maximum magnitude of the second offset may be greater than 1 LSB.

The plurality of negative offset current cells 22 (e.g., the first to M-th negative offset current cells 22_1 to 22_M) may each include a third current source CS3 and a third selection circuit SC3. The third current source CS3 may generate the second offset current I_{OFS2}.

The third selection circuit SC3 may receive second offset current I_{OFS2} from the main current cell MCC or from the second power node NP2. The third selection circuit SC3 may include a fifth switch SW5 and a sixth switch SW6 that operate complementarily. The fifth switch SW5 may be turned on to receive the second offset current I_{OFS2} from the main current source MCC, and the sixth switch SW6 may be turned on to receive the second offset current I_{OFS2} from the second power node NP2. When the negative offset current cell 22 is turned on, the fifth switch SW5 may be turned on to receive the second offset current I_{OFS2} from the main current source MCC, and, when the negative offset current cell 22 is turned off, the sixth switch SW6 may be turned on to receive the second offset current I_{OFS2} from the second power node NP2.

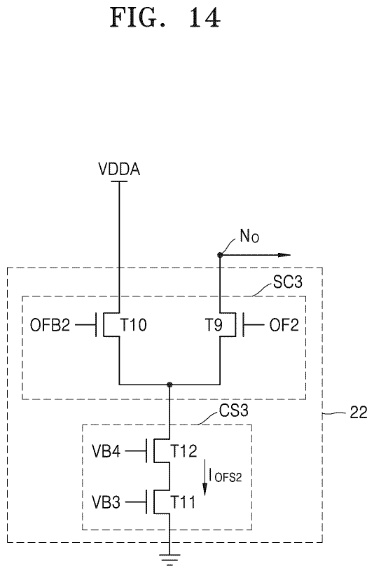

FIG. 14 is a diagram showing the negative offset current cell 22 of FIG. 13B.

Referring to FIG. 14 and FIG. 13B, the negative offset current cell 22 may include the third selection circuit SC3 and the third current source CS3, the third selection circuit SC3 may include a ninth transistor T9 and a tenth transistor T10, and the third current source CS3 may include an eleventh transistor T11 and a twelfth transistor T12.

The ninth transistor T9 and the tenth transistor T10 may correspond to the fifth switch SW5 and the sixth switch SW6 of FIG. 13B, respectively. The ninth transistor T9 and the tenth transistor T10 may be turned on and turned off in response to a second offset control signal OF2 and a second offset control bar signal OFB2, respectively. The second offset control bar signal OFB2 is the complementary signal of the second offset control signal OF2. The ninth transistor T9 may be turned on in response to an active level (e.g., logic high) of the second offset control signal OF2, and the tenth transistor T10 may be turned on in response to an active level (e.g., logic high) of the second offset control bar signal OFB2.

The third selection circuit SC3 has a structure in which the eleventh transistor T11 and the twelfth transistor T12 are stacked, and the eleventh transistor T11 and the twelfth transistor T12 may generate the second offset current I_{OFS2} based on a third bias voltage VB3 and a fourth bias voltage VB4. The eleventh transistor T11 corresponds to a bias stage and may generate the second offset current I_{OFS2} in a current mirroring manner based on the third bias voltage VB3 received from a bias circuit. The twelfth transistor T12 corresponds to a cascode stage and may determine a direct current (DC) operating voltage of the negative offset current cell 22.

As described above, the magnitude of the second offset current I_{OFS2} may be equal to 1/R times the magnitude of the reference current I_{R}. The size of the eleventh transistor T11 may be determined based on a ratio between the magnitude of the reference current I_{R} and the magnitude of the second offset current I_{OFS2}, and the third bias voltage VB3.

In FIG. 13B, the third bias voltage VB3 and the fourth bias voltage VB4 are provided to the plurality of negative offset current cells 22 (e.g., the first to M-th negative offset current cells 22_1 to 22_M), and the second offset control signal OF2 and the second offset control bar signal OFB2 provided to each of the first to M-th negative offset current cells 22_1 to 22_M may be different.

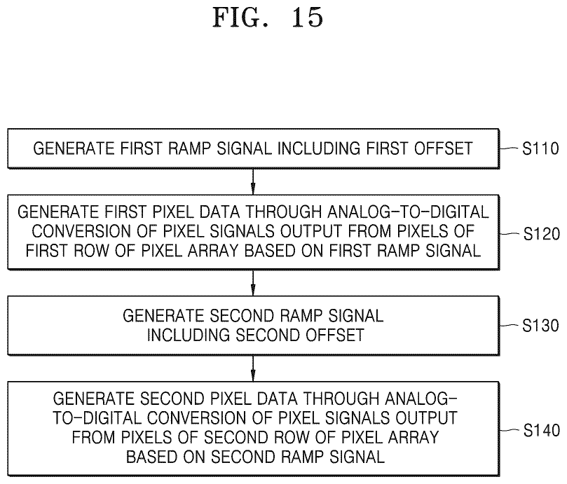

FIG. 15 is a flowchart of a method of operating an image sensor, according to an embodiment. The method of FIG. 15 may be applied to the image sensor 100 of FIG. 1, and descriptions given above with reference to FIGS. 1 to 14 may be applied to the present embodiment.

Referring to FIG. 1 and FIG. 15, the ramp signal generator 140 may generate a first ramp signal including a first offset (operation S110). The ramp signal generator 140 may generate the first ramp signal by adding the first offset to the reference ramp signal during a first read-out period. The ramp signal generator 140 may provide the first ramp signal to the plurality of comparators 131 of the ADC circuit 130.

The ADC circuit 130 may generate first pixel data through analog-to-digital conversion of pixel signals output from pixels of a first row of the pixel array 110 based on the first ramp signal (operation S120). During the first read-out period, the pixel array 110 may output pixel signals from the pixels of the first row. The plurality of comparators 131 may each compare the first ramp signal with a pixel signal to generate a comparison result signal, and the plurality of counters 132 may each generate a pixel value based on received comparison result signal.

A pixel signal may include a reset signal and an image signal. The comparator 131 may compare the reset signal with the first ramp signal to generate a first comparison result signal, and the counter 132 may generate a reset value based on the first comparison result signal. A comparator 131 may generate a second comparison result signal by comparing an image signal with the first ramp signal, and the counter 132 may generate a signal value based on the second comparison result signal. The comparator 131 or a separate logic may subtract a reset value from a signal value to calculate a pixel value corresponding to a pixel signal. In this way, the ADC circuit 130 may perform a CDS operation based on the first ramp signal to generate pixel values. The first pixel data may include pixel values corresponding to pixel signals output from a first row of the pixel array 110.

The ramp signal generator 140 may generate a second ramp signal including a second offset (operation S130). The ramp signal generator 140 may generate a second ramp signal by adding the second offset to the reference ramp signal during a second read-out period. The second offset is different from the first offset. According to an embodiment, the second offset and the first offset may have the same magnitude and opposite symbols.

The ADC circuit 130 may generate second pixel data through analog-to-digital conversion of pixel signals output from pixels of a second row of the pixel array 110 based on the second ramp signal (operation S130). During the second read-out period, the pixel array 110 may output pixel signals from the pixels of the second row. The ADC circuit 130 may perform a CDS operation based on the second ramp signal to generate pixel values. The second pixel data may include pixel values corresponding to pixel signals output from the second row of the pixel array 110.

In this way, the ramp signal generator 140 may generates ramp signals including different offsets for respective read-out periods, and the ADC circuit 130 may perform analog-to-digital conversion of pixel signals based on the ramp signals including offsets. Analog dithering may be applied during a CDS operation of the ADC circuit 130. Therefore, the VFPN caused by quantization error occurring during the analog-to-digital conversion process may be enhanced (reduced).

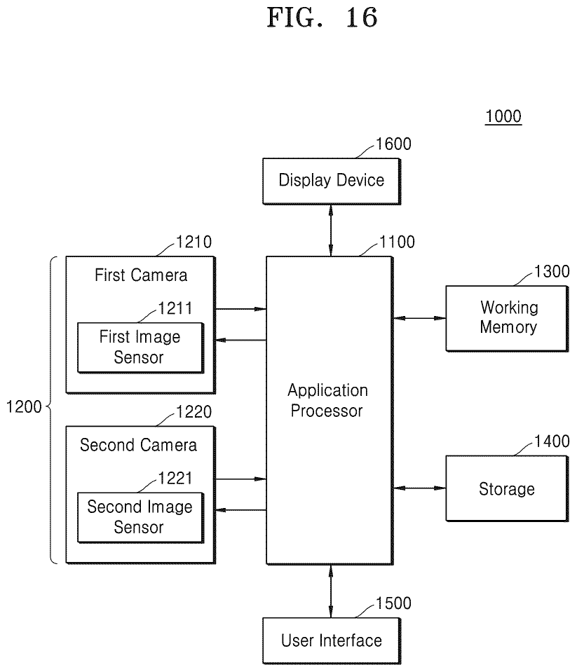

FIG. 16 is a block diagram showing an electronic apparatus including an image sensor, according to an embodiment.

An electronic apparatus 1000 may be a portable terminal configured to detect light and capture an image.

The electronic apparatus 1000 may include an application processor 1100, a camera module 1200, a display device 1600, a working memory 1300, a storage 1400, and a an user interface 1500. The electronic apparatus 1000 may further include other general-purpose components, such as a communication module, a sensor module, etc.

The application processor 1100 controls the overall operation of the electronic device 1000 and may be implemented as a system-on-chip (SoC) that drives an application program, an operating system, etc. The application processor 1100 may provide image data provided from the camera module 1200 to the display device 1600 or store the image data in the storage 1400. According to an embodiment, the application processor 1100 may be equipped with an image processing circuit and may perform image processing such as image quality adjustment, data format change, and high dynamic range (HDR) processing on image data received from the camera module 1200.

The camera module 1200 may include plurality of cameras, such as a first camera 1210 and a second camera 1220. The first camera 1210 and the second camera 1220 may include a first image sensor 1211 and a second image sensor 1221, respectively. At least one of the first image sensor 1211 and the second image sensor 1221 may be implemented as the image sensor 100 described with reference to FIGS. 1 to 15. For example, the first image sensor 1211 may apply analog dithering to a CDS operation as described above with reference to FIGS. 1 to 15. A ramp signal generator provided in the first image sensor 1211 may generate a ramp signal including an offset, and the offset may be changed in each read-out period. As an ADC circuit performs CDS based on a ramp signal having an offset changed in every read-out period, analog dithering may be applied.

The application processor 1100 may transmit sensor control signals for controlling operations of the first image sensor 1211 and the second image sensor 1221 to the first image sensor 1211 and the second image sensor 1221. The sensor control signals may include, for example, setting values and configuration data for selecting operating modes, shuttering modes, etc. of the first image sensor 1211 and the second image sensor 1221. For example, configuration data may include exposure time settings, analog gain, digital gain, lens shading compensation values, crosstalk coefficients, frame rate settings, etc. Transmission of the sensor control signals may be performed based on an interface (e.g., an inter-integrated circuit (I2C)).

The first image sensor 1211 and the second image sensor 1221 may operate based on received sensor control signals. According to an embodiment, the first image sensor 1211 may apply analog dithering to a CDS operation when an analog gain received from the application processor 1100 is less than or equal to a reference value, and may not apply analog dithering to the CDS operation when the analog gain is greater than the reference value.

The first image sensor 1211 and the second image sensor 1221 may transmit image data or signal processed image data to the application processor 1200. Transmission of image data may be performed by using a camera serial interface (CSI) based on the mobile industry processor interface (MIPI), but embodiments are not limited thereto.

The working memory 1300 may be implemented by a volatile memory like DRAM or SRAM or a non-volatile resistive memory like a ferroelectric RAM (FeRAM), RRAM, or a phase-change RAM (PRAM). The working memory 1300 may store programs and/or data processed or executed by the application processor 1100.

The storage 1400 may be implemented as a non-volatile memory device such as NADN flash or resistive memory. For example, the storage 1400 may be provided as a memory card (MMC, eMMC, SD, micro SD), etc. The storage 1400 may store image data provided from the camera module 1200.

The user interface 1500 may be implemented with various devices capable of receiving user inputs (e.g., a keyboard, a curtain key panel, a touch panel, a fingerprint sensor, a microphone, etc.). The user interface 1500 may receive a user input and provide a signal corresponding to the received user input to the application processor 1100.

While the inventive concept has been particularly shown and described with reference to embodiments thereof, it will be understood that various changes in form and details may be made therein without departing from the spirit and scope of the following claims.

What is claimed is:

1. An image sensor comprising:
a pixel array comprising a plurality of pixels and a plurality of column lines connected to the plurality of pixels;
a ramp signal generator configured to generate a ramp signal and adjust an offset of the ramp signal at each read-out period of the pixel array; and
an analog-to-digital conversion circuit comprising a plurality of comparators configured to receive a plurality of pixel signals from the plurality of column lines and the ramp signal from the ramp signal generator, compare each of the plurality of pixel signals with the ramp signal to obtain a plurality of comparison results, and perform analog-to-digital conversion on the plurality of comparison results to generate pixel data corresponding to the plurality of pixel signals, respectively.

2. The image sensor of claim 1, wherein the ramp signal generator is further configured to generate a first ramp signal comprising a first offset as the ramp signal in a first read-out period and generate a second ramp signal comprising a second offset as the ramp signal in a second read-out period that follows directly after the first read-out period, and
wherein the ramp signal generator is further configured to adjust the second offset of the second ramp signal to be different from the first offset of the first ramp signal, and set a slope of the second ramp signal to be equal to a slope of the first ramp signal.

3. The image sensor of claim 2, wherein the first offset in the first ramp signal generated during the first read-out period of each frame is consistent, and
the second offset in the second ramp signal generated during the second read-out period of each frame is consistent.

4. The image sensor of claim 1, wherein the plurality of comparators comprises a first comparator connected to an even column line and a second comparator connected to an odd column line, among the plurality of column lines, and
wherein the ramp signal generator comprises:
a first ramp signal generator configured to generate a first ramp signal comprising a first offset, and provide the first ramp signal to the first comparator that is connected to the even column line; and
a second ramp signal generator configured to generate a second ramp signal comprising a second offset, and provide the second ramp signal to the second comparator that is connected to the odd column line, and
the first offset and the second offset have a same magnitude and opposite signs.

5. The image sensor of claim 1, wherein the ramp signal generator comprises:
a resistor connected to an output node of the ramp signal generator from which the ramp signal is output;
a plurality of first current cells configured to generate a reference current provided to the resistor; and
a plurality of second current cells configured to generate an offset current, and
wherein the offset current is less than or equal to the reference current.

6. The image sensor of claim 5, wherein, among the plurality of second current cells, a number of second current cells in an on state that provide the offset current to the resistor is changed for each of the read-out periods.

7. The image sensor of claim 5, wherein the plurality of second current cells comprise M second current cells, and
wherein the offset current is 1/M times the reference current, and M is an integer greater than or equal to 2.

8. The image sensor of claim 5, wherein at least one of the plurality of second current cells is configured to generate a positive offset current, and
wherein at least another one of the plurality of second current cells is configured to generate a negative offset current.

9. The image sensor of claim 1, wherein one frame period comprises a plurality of read-out periods, and a sum of a plurality of offsets included in the ramp signal in the plurality of read-out periods is zero.

10. The image sensor of claim 1, wherein the ramp signal generator is further configured to generate the ramp signal comprising the offset based on an analog gain set to the image sensor being lower than or equal to a reference value, and generate the reference ramp signal as the ramp signal based on the analog gain being greater than the reference value.

11. A method of operating an image sensor comprising a pixel array comprising a plurality of pixels, the method comprising:
generating a first ramp signal comprising a first offset;
receiving first pixel signals from pixels in a first row of the pixel array, among the plurality of pixels;
generating first pixel data by performing analog-to-digital conversion on the first pixel signals based on the first ramp signal;
generating a second ramp signal comprising a second offset different from the first offset;
receiving second pixel signals from pixels in a second row of the pixel, among the plurality of pixels; and
generating second pixel data by performing analog-to-digital conversion on the second pixel signals based on the second ramp signal.

12. The method of claim 11, wherein a slope of the first ramp signal is equal to a slope of the second ramp signal.

13. The method of claim 11, wherein, in each frame, the first offset in the first ramp signal is consistent, and,
in each frame, the second offset in the second ramp signal is consistent.

14. The method of claim 11, wherein minimum values of the first offset and the second offset are less than or equal to a unit change amount of the ramp signal corresponding to least significant bits of the first pixel data and the second pixel data.

15. The method of claim 11, wherein the generating of the first pixel data comprises:
generating a reset value based on a first comparison signal generated by comparing a reset signal output as a first pixel signal from each pixel in the first row with the first ramp signal during a reset read-out period;
generating a signal value based on a second comparison signal generated by comparing an image signal output as a first pixel signal from each pixel in the first row with the first ramp signal during a signal read-out period; and
generating pixel data by subtracting the reset value from the signal value, and
a same offset magnitude is applied to the first ramp signal during the reset read-out period and the signal read-out period.

16. An electronic apparatus comprising:
an image sensor comprising a pixel array comprising a plurality of pixels, wherein the image sensor is configured to generate a ramp signal by adding an offset, which is set differently for each of a plurality of rows of the pixel array, to a reference ramp signal during each read-out period, generate a plurality of comparison result signals by comparing the ramp signal with a plurality of pixel signals that is output from the plurality of pixels, respectively, and generate image data through analog-to-digital conversion of the plurality of comparison result signals; and
a processor configured to process the image data received from the image sensor.

17. The electronic apparatus of claim 16, wherein the processor is further configured to generate an analog gain that changes depending on illuminance outside the electronic apparatus and provide the analog gain to the image sensor, and
wherein the image sensor is further configured to generate the ramp signal comprising a different offset for each of a plurality of read-out periods when the analog gain is lower than or equal to a reference value, and generate the same reference ramp signal as the ramp signal during the plurality of read-out periods when the analog gain is greater than the reference value.

18. The electronic apparatus of claim 16, the offset in the ramp signal during a same read-out period in each frame is consistent.

19. The electronic apparatus of claim 16, wherein the plurality of pixel signals comprises first pixel signals that are output from odd column lines of the pixel array, and second pixel signals that are output from even column lines of the pixel array,
wherein the image sensor is further configured to generate a first ramp signal comprising a first offset and a second ramp signal comprising a second offset, compare the first pixel signals with the first ramp signal, and compare the second pixel signals with the second ramp signal, and
wherein the first offset and the second offset are of a same magnitude and have opposite signs.

20. The electronic apparatus of claim 16, wherein a sum of a plurality of offsets included in the ramp signal during a plurality of read-out periods included in one frame is zero.
